(19) United States
(12) Patent Application Publication
(10) Pub. No.: US 2010/0092767 A1
(43) Pub. Date: Apr. 15, 2010

(54) BONDING METHOD AND BONDED BODY

(75) Inventors: Nobuhiro NAITO, Chino (JP); Mitsuru SATO, Suwa (JP); Takatoshi YAMAMOTO, Suwa (JP); Minehiro IMAMURA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/577,314

(22) Filed: Oct. 12, 2009

(30) Foreign Application Priority Data
Oct. 15, 2008 (JP) 2008-266673

(51) Int. Cl. B32B 9/04; B65C 9/25; B29C 65/14

(52) U.S. Cl. 428/336; 156/322; 156/272.6

(57) ABSTRACT

A bonding method includes applying a liquid material containing silicone materials to at least one of the first base member and the second base member so as to form a liquid film, drying the liquid film so as to obtain a bonding film on the at least one of the first base member and the second base member, heating the bonding film so as to cross-link the silicone materials contained in the bonding film to each other, and applying energy to the bonding film so as to develop adhesiveness around a surface of the bonding film so as to obtain a bonded body in which the first base member and the second base member are bonded to each other with the bonding film interposed between the first base member and the second base member.

The entire disclosure of Japanese Patent Application No. 2008-266673, filed Oct. 15, 2008 is expressly incorporated by reference herein.

### BACKGROUND

1. Technical Field

The present invention relates to a bonding method and a bonded body.

2. Related Art

When two members (base members) are bonded (adhesively bonded) together, methods using adhesives, such as an epoxy adhesive, an urethane adhesive, and a silicone adhesive, are often employed. The adhesives generally exhibit excellent adhesiveness regardless of materials of the members. Therefore, members made of various materials can be bonded to each other in different combinations by a use of the adhesives.

In bonding the members together with an adhesive, a liquid adhesive or a pasty adhesive is applied on a bond surface so as to bond the members together with the applied adhesive interposed therebetween. Then, heat or light is applied to cure (solidify) the adhesive, thereby bonding the members together. In a case where the bonding employing such the adhesive is applied to a droplet discharge head (an inkjet recording head) included to an inkjet printer, the droplet discharge head includes components made of different materials, such as resin, metal, or silicon, which are bonded together by using the adhesive (for example, refer to JP-A-5-155017).

However, if the adhesive is used for bonding a nozzle plate, which is included to the droplet discharge head and nozzles are formed therein, and a substrate partitioning ink chambers, the adhesive is exposed to ink stored in the ink chamber for a long period of time. The adhesive exposed to ink for a long period of time is altered and deteriorated by organic components in the ink. As a result, ink characteristics are degraded due to degradation of liquid tightness of the ink chamber and elution of components from the adhesive.

### SUMMARY

An advantage of the invention is to provide a bonding method that allows a bonding film, which is provided for bonding two base members together, to have excellent solvent resistance and to provide a bonded body having excellent solvent resistance obtained by bonding the members by the bonding method.

According to a first aspect of the invention, a bonding method includes applying a liquid material containing silicone materials to at least one of the first base member and the second base member so as to form a liquid film, drying the liquid film so as to obtain a bonding film on the at least one of the first base member and the second base member, heating the bonding film so as to cross-link the silicone materials contained in the bonding film to each other, and applying energy to the bonding film so as to develop adhesiveness around a surface of the bonding film so as to obtain a bonded body in which the first base member and the second base member are bonded to each other with the bonding film interposed between the first base member and the second base member. Accordingly, the bonding film provided for bonding two base members together can exhibit excellent solvent resistance. This can appropriately suppress or prevent warpage from occurring at the bonded body and air bubbles from remaining in the bonding film.

According to a second aspect of the invention, a bonding method includes applying a liquid material containing silicone materials to at least one of the first base member and the second base member so as to form a liquid film, drying the liquid film so as to obtain a bonding film on the at least one of the first base member and the second base member, applying energy to the bonding film so as to develop adhesiveness around a surface of the bonding film so as to obtain a bonded body in which the first base member and the second base member are bonded to each other with the bonding film interposed between the first base member and the second base member, and heating the bonding film so as to cross-link the silicone materials contained in the bonding film to each other. Accordingly, the bonding film provided for bonding two base members together can exhibit excellent solvent resistance.

In the bonding method of the invention, the bonding film is preferably heated at a temperature ranging from 80° C. to 250° C. Accordingly, solvent resistance of the bonding film can be more securely improved, and the bonding film can be obtained that preferably develops adhesiveness when energy is applied thereto.

In the bonding method of the invention, the bonding film is preferably heated for 0.2 hours to 15 hours. Accordingly, solvent resistance of the bonding film can be more securely improved, and the bonding film can be obtained that preferably develops adhesiveness when energy is applied thereto.

In the bonding method of the invention, the energy is preferably applied by bringing plasma into contact with the bonding film. The method allows the energy to be relatively easily applied to the bonding film and to be selectively applied to around the surface, and thus is used as a suitable energy application method.

In the bonding method of the invention, the plasma contact is preferably performed in atmospheric pressure. According to the plasma contact performed in atmospheric pressure, that is, the atmospheric-pressure plasma treatment, a surrounding area of the bonding film does not become a reduced pressure state. Therefore, when methyl groups included in the polydimethilsiloxane skeleton contained in the silicone material forming the bonding film, for example, are cleaved and removed to develop adhesiveness around the surface of the bonding film, the plasma acts to prevent unwanted progress of the cleaving.

In the bonding method of the invention, the plasma contact is preferably performed by introducing a gas between electrodes opposed to each other so as to convert the gas into plasma while a voltage is applied between the electrodes so as to supply the bonding film with the gas converted into plasma. Accordingly, the plasma contact with the bonding film can be easily and reliably performed so as to securely develop the adhesiveness around the surface of the bonding film.

In the bonding method of the invention, the plasma is preferably obtained by converting a gas mainly containing a helium gas. Accordingly, the extent of activation of the bonding film is easily controlled.

In the bonding method of the invention, the silicone materials preferably include polyorganosiloxane skeletons as a main skeleton. A compound including methyl groups is preferably used as the silicone material since the compound is relatively easily available at low cost. Further, when the energy is applied to the bonding film containing the compound, the methyl groups constituting the compound are easily cleaved, and thereby the adhesiveness is securely developed on the bonding film.

In the bonding method of the invention, the silicone materials preferably include silanol groups, and the silanol groups included in the adjacent silicone materials react so as to cross-link the silicone materials to each other. Accordingly, the bonding film to be obtained has excellent film strength, exhibiting excellent solvent resistance.

In the bonding method of the invention, the bonding film preferably has an average thickness of 10 nm to 10,000 nm. Accordingly, it is possible to prevent significant reduction in dimensional accuracy of a bonded body obtained by bonding the first base member and the second base member together, as well as to increase bonding strength between the base members.

In the bonding method of the invention, at least portions of the first base member and the second base member contacting the bonding film preferably is mainly made of one of a silicon material, a metal material, and a glass material. Thereby, without any surface treatment, sufficient bonding strength can be obtained.

In the bonding method of the invention, surfaces of the first base member and the second base member contacting with the bonding film are preferably surface treated in advance so as to increase adhesiveness with the bonding film. Accordingly, a bond surface of the base member is cleaned and activated due to the surface treatment, whereby the bonding film easily acts chemically on the bond surface. As a result, the bonding strength between the bond surface of the base member and the bonding film can be enhanced.

In the bonding method of the invention, the surface treatment preferably is one of a plasma treatment and an ultraviolet (UV) radiation treatment. This can particularly optimize the surface of the base member so as to form the bonding film thereon.

According to a third aspect of the invention, a bonded body is obtained by bonding the first base member and the second base member with the bonding film interposed therebetween by the bonding method of the first aspect. Accordingly, a highly reliable bonded body can be obtained.

### BRIEF DESCRIPTION OF THE DRAWINGS

The invention will be described with reference to the accompanying drawings, wherein like numbers reference like elements.

FIGS. 1A to 1E are vertical sectional views for explaining a bonding method of a first embodiment of the invention.

FIGS. 2F and 2G are vertical sectional views for explaining the bonding method of the first embodiment of the invention.

FIG. 3 is a schematic view showing a structure of an atmospheric-pressure plasma apparatus.

FIGS. 4A to 4D are vertical sectional views for explaining a bonding method of a second embodiment of the invention.

FIGS. 5E, 5F, and 5G are vertical sectional views for explaining the bonding method of the second embodiment of the invention.

FIGS. 6A, 6B and 6C are vertical sectional views for explaining a bonding method of a third embodiment of the invention.

FIG. 7 is an exploded perspective view of an inkjet type recording head (a droplet discharge head) obtained by applying a bonded body according to the embodiment of the invention.

FIG. 8 is a sectional view showing a structure of a main part of the inkjet type recording head of FIG. 7.

FIG. 9 is a schematic view showing an embodiment of an inkjet printer including the inkjet type recording head of FIG. 7.

### DESCRIPTION OF EXEMPLARY EMBODIMENTS

A bonding method and a bonded body of the invention will now be described in detail based on preferred embodiments with reference to the accompanying drawings.

Bonding Method

Hereafter, the bonding method according to a first embodiment of the invention will be described by each step.

### First Embodiment

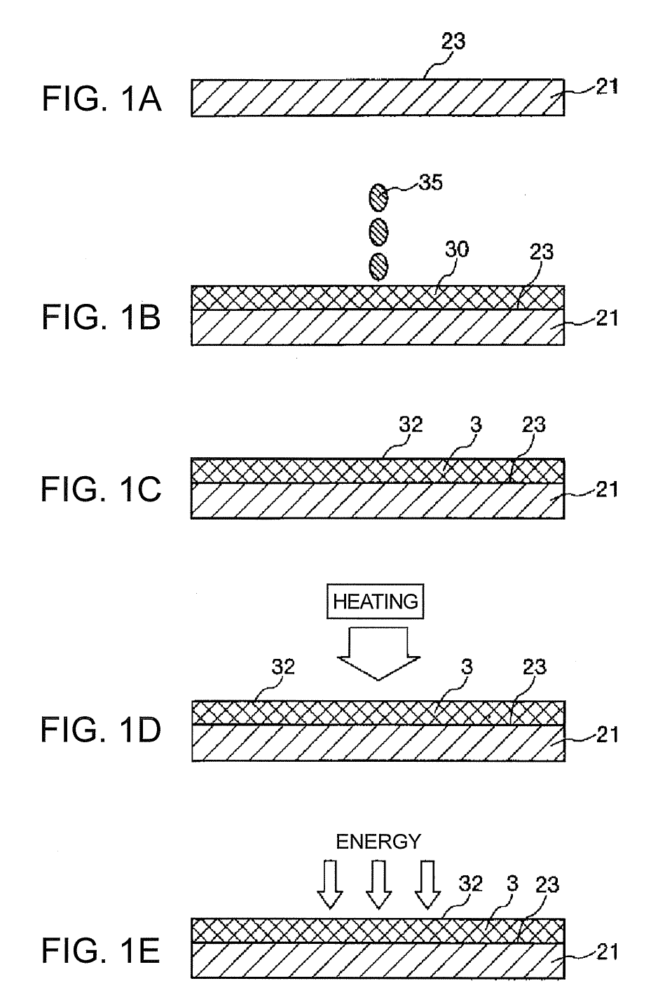

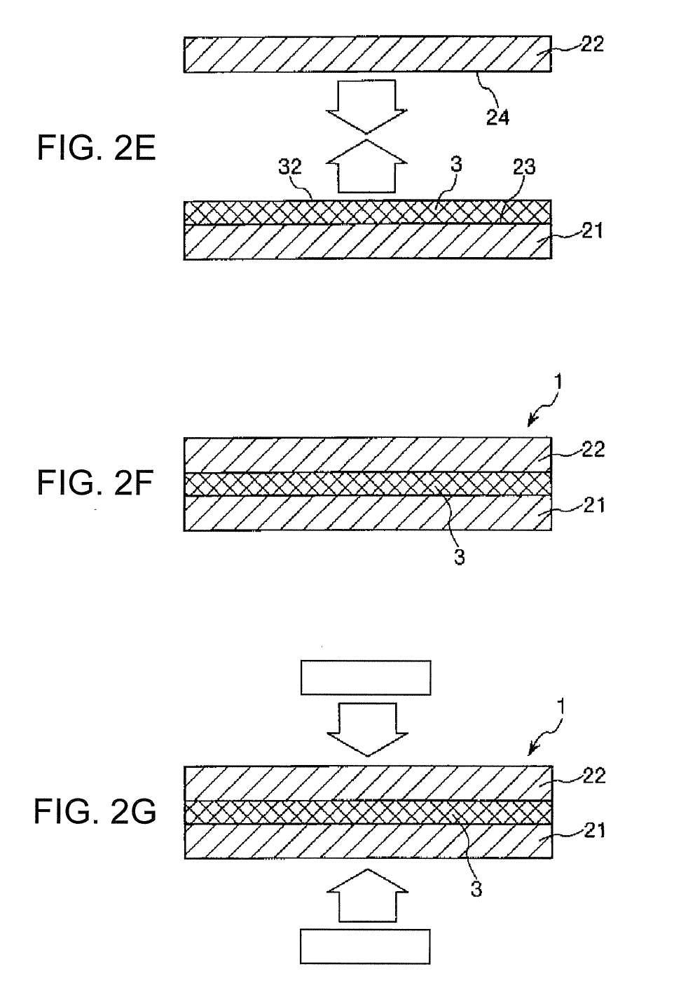

FIGS. 1A, 1B, 1C, 1D, 1E, 2F, and 2G are diagrams (vertical sectional views) for explaining the first embodiment exemplifying the bonding method of the invention. Here, the upper side of FIGS. 1A to 2G is referred to as “upper” and the lower side of the same is referred to as “lower” in the following descriptions. The bonding method of the present embodiment includes the following steps: [1] preparing a first base member 21 and a second base member 22 that are to be bonded to each other with a bonding film interposed therebetween, and applying a liquid material containing a silicone material to the first base member 21 so as to form a liquid film 30, [2] drying the liquid film so as to obtain a bonding film 3 on the first base member 21, [3] heating the bonding film 3 so as to cross-link the silicone materials contained in the bonding film 3 to each other, and [4] applying energy to the bonding film 3 so as to develop adhesiveness around a surface of the bonding film 3 so as to obtain a bonded body 1 in which the first base member 21 and the second base member 22 are bonded to each other with the bonding film 3, on which the adhesiveness is developed, interposed therebetween.

[1] Forming Liquid Film

[1-1] As shown in FIG. 1A, the first base member 21 and the second base member 22 are first prepared. Here, FIG. 1A does not show the second base member 22. Though materials of the first base member 21 and the second base member 22 are not limited, the first base member 21 and the second base member 22 may be made of, for example, polyolefins such as polyethylene, polypropylene, ethylene-propylene copolymer, ethylene-acrylic acid ester copolymer, ethylene-acrylic acid copolymer, polybutene-1, and ethylene-vinyl acetate copolymer (EVA); polyesters such as cyclic polyolefin, modified polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate (PMMA), acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), and polycyclohexylenedimethylene terephthalate (PCT); polyether; polyetherketone (PEK); polyether ether ketone (PEEK); polyetherimide; polyacetal (polyoxymethylene:POM); polyphenyleneoxide; modified-polyphenyleneoxide; polysulfone; polyethersulfone; polyphenylene sulfide; polyarylate; aromatic polyester (liquid crystal polymer); polytetrafluoroethylene; polyvinylidene fluoride; other fluororesins; stylene-, polyolefin-, polyvinyl chloride-, polyurethane-, polyester-, polyamide-, polybutadiene-, trans-polyisoprene-, fluoro rubber-, and chlorinated polyethylene-thermosetting elastomers; resins such as epoxy resin, phenol resin, urea resin, melamine resin, aramid resin, unsaturated polyester, silicone resin, polyurethane, copolymers mainly containing these resins, polymer blends, and polymer alloys; metals such as Fe, Ni, Co, Cr, Mn, Zn, Pt, Au, Ag, Cu, Pd, Al, W, Ti, V, Mo, Nb, Zr, Pr, Nd, and Sm, an alloy of these metals; metal materials such as carbon steel, stainless steel, indium-tin oxide (ITO), and gallium arsenide; silicon materials such as monocrystalline silicon, polycrystalline silicon, and amorphous silicon; glass materials such as silicate glass (silica glass), alkaline silicate glass, soda-lime glass, potash-lime glass, lead-alkali glass, barium glass, and borosilicate glass; ceramic materials such as alumina, zirconia, MgAl₂O₄, ferrite, silicon nitride, aluminum nitride, boron nitride, titanium nitride, silicon carbide, boron carbide, titanium carbide, and tungsten carbide; or carbon materials such as graphite. These materials may be used singly or used as a composite material including two or more.

A surface treatment may be performed on a surface of each of the first and the second base members 21 and 22. The surface treatment may be a plating treatment such as Ni plating, a passivation treatment such as chromating, a nitriding treatment, or the like. The first and the second base members 21 and 22 may be made of the same material or different materials.

The first and the second base members 21 and 22 preferably have thermal expansion coefficients that are substantially the same. When the first and the second base members 21 and 22 having substantially the same thermal expansion coefficients are bonded to each other, stress caused by thermal expansion hardly occurs at a bonded interface. As a result, separation between the base members of the bonded body 1, which is eventually obtained, can be securely prevented. Even in a case where the thermal expansion coefficients of the first and second base members 21 and 22 are different from each other, the base members 21 and 22 can be firmly bonded to each other with high dimensional accuracy by optimizing conditions for bonding the base members in a step described in detail below.

Further, the base members 21 and 22 preferably have different rigidity. Accordingly, the base members 21 and 22 can be more firmly bonded to each other. In addition, at least one of the base members 21 and 22 is preferably made of a resin material. The flexibility of resin allows reducing stress (for example, stress due to thermal expansion) occurring at the bonded interface between the two base members 21 and 22 bonded to each other. Accordingly, the bonded interface is hardly damaged, being able to obtain the bonded body 1 in which the base members 21 and 22 are bonded to each other with high bonding strength.

According to the viewpoint described above, it is preferable that at least one of the base members 21 and 22 have flexibility. Accordingly, the bonding strength between the base members 21 and 22 that are bonded to each other with the bonding film 3 interposed therebetween can be further improved. In a case where the base members 21 and 22 both have flexibility, the obtained bonded body 1 as a whole has flexibility so as to be highly functional. Each of the base members 21 and 22 may have any shape as long as they have a surface supporting the bonding film 3. For example, the base member may be plate-shaped (layer-shaped), block- or bar-shaped.

In the present embodiment, each of the base members 21 and 22 are plate-shaped as shown in FIGS. 1A to 2G. Accordingly, each of the base members 21 and 22 are easily bent. Therefore, when the base members 21 and 22 are superposed on each other, they are substantially deformed along each shape. Accordingly, adhesiveness between the two base members that are superposed is increased, increasing the bonding strength between the base members 21 and 22 in the bonded body 1 which is eventually obtained. Additionally, flexion of each of the base members 21 and 22 can favorably reduce stress occurring at the bonded interface to some extent. In this case, an average thickness of each of the base members 21 and 22 is not limited to a specific value, but preferably ranges approximately from 0.01 mm to 10 mm, and more preferably approximately from 0.1 mm to 3 mm.

Next, a surface treatment is performed on a bonding surface 23 of the first base member 21 as necessary so as to increase adhesiveness with the bonding film 3 to be formed on the bonding surface 23. The surface treatment cleans and activates the bond surface 23, whereby the bonding film 3 easily acts chemically on the bond surface 23. As a result, the bonding strength between the bond surface 23 and the bonding film 3 can be increased when the bonding film 3 is formed on the bond surface 23 in a step described below.

The surface treatment is not specifically limited, but may be a physical surface treatment such as sputtering and blast treatment; a chemical surface treatment such as a plasma treatment using oxygen plasma or nitrogen plasma, corona discharge, etching, electron beam radiation, UV radiation, and ozone exposure; or a combination of these treatments. In a case where the first base member 21 to which a surface treatment is to be performed is made of a resin material (a polymeric material), especially the corona discharge treatment, the nitrogen plasma treatment, or the like are preferably used.

The plasma treatment or the UV radiation treatment performed as a surface treatment can further clean and activate the bond surface 23. As a result, the bonding strength between the bond surface 23 and the bonding film 3 can be especially improved. Depending on the material of the first base member 21, the bonding strength between the bond surface 23 and the bonding film 3 can be sufficiently increased without performing the surface treatment as above. Examples of such the effective material for the first base member 21 include materials mainly containing the above-described various metal materials, silicon materials, and glass materials.

The first base member 21 made of any of the above materials has a surface covered with an oxide film having hydroxyl groups bonded to (exposed on) the surface thereof. With the first base member 21 having the surface covered with the oxide film, the bonding strength between the bond surface 23 of the first base member 21 and the bonding film 3 can be enhanced without performing the surface treatment as above. In this case, the whole of the first base member 21 is not necessarily be made of any of the materials above. It is only necessary that at least a part of the first base member 21 around the bond surface 23, on which the bonding film 3 is to be formed, is made of any of the materials.

Alternatively, an intermediate layer may be formed in advance on the bond surface 23 of the first base member 21, instead of the surface treatment. The intermediate layer can have any function, but preferably has a function of increasing the adhesiveness with the bonding film 3, a cushioning function (a buffer function), a function of reducing stress concentration, and the like, for example. The bonding film 3 is formed on such the intermediate layer, eventually providing the bonded body 1 which is highly reliable.

The intermediate layer is made of; metal materials such as aluminum and titanium; oxide materials such as metal oxide and silicon oxide; nitride materials such as metal nitride and silicon nitride; carbon materials such as graphite and diamond like carbon; self-assembled film materials such as a silane coupling agent, a thiol compound, metal alkoxide, and a metal-halogen compound; and resin materials such as a resin adhesive, a resin film, a resin coating material, various rubber materials, and various elastomers. These materials may be used singly or used in a combination of two or more.

Among those kinds of the materials, particularly, using the oxide materials for the intermediate layer can especially increase the bonding strength between the first base member 21 and the bonding film 3. On the other hand, similarly to the first base member 21, a surface treatment may be performed in advance on a bond surface 24 of the second base member 22 (a surface closely brought into contact with the bonding film 3 in a step described below), as necessary, so as to increase the adhesiveness with the bonding film 3. The surface treatment cleans and activates the bond surface 24. As a result, when the bond surface 24 is closely brought into contact with the bonding film 3, the bonding strength between the bond surface 24 and the bonding film 3 can be enhanced in the step described below.

The surface treatment for the bond surface 24 is not specifically limited, but may be the same treatment as that performed on the bond surface 23 of the first base member 21 described above. Similarly to the first base member 21, depending on the material of the second base member 22, the adhesiveness with the bonding film 3 can be sufficiently enhanced without performing the surface treatment as above. Such the effective material for the second base member 22 may be a material mainly containing the various metal materials, the silicon materials, and the glass materials described above.

The second base member 22 made of any of the above material has a surface covered with an oxide film having hydroxyl groups bonded to (exposed on) the surface thereof. With the second base member 22 having the surface covered with the oxide film, the bonding strength between the bond surface 24 of the second base member 22 and the bonding film 3 can be enhanced without performing the surface treatment as above. In this case, the whole of the second base member 22 is not necessarily be made of any of the above materials. It is only necessary that at least a part of the second base member 22 around the bond surface 24 is made of any of the materials. In a case where the bond surface 24 of the second base member 22 includes a group or a substance below, the bonding strength between the bond surface 24 of the second base member 22 and the bonding film 3 can be sufficiently enhanced without performing the surface treatment as above.

The group or the substance is at least a single group or a substance selected from the following groups and substances or a free bond (a dangling bond) which is linked to an atom and is not terminated because the following groups are cleaved. The group or the substance is, for example, various functional groups such as a hydroxyl group, a thiol group, a carboxyl group, an amino group, a nitro group, and an imidazole group; various radicals; leaving intermediate molecules having ring-opening molecules or unsaturated bonds such as double bonds and triple bonds; halogens such as F, Cl, Br, and I; or peroxide.

The leaving intermediates molecules preferably are hydrocarbon molecules having the ring-opening molecule or the unsaturated bond. The hydrocarbon molecules strongly act on the bonding film 3 based on a significant reactivity of the ring-opening molecules and the unsaturated bonds. Therefore, the bond surface 24 including such the hydrocarbon molecules can be strongly bonded to the bonding film 3. Additionally, it is especially preferable that the functional groups included in the bond surface 24 be hydroxyl groups. Accordingly, the bond surface 24 can be especially easily and strongly bonded to the bonding film 3. Specifically, in a case where the hydroxyl groups are exposed on the surface of the bonding film 3, the bond surface 24 and the bonding film 3 can be strongly bonded together in a short time based on a hydrogen bond occurring between hydroxyl groups of the bond surface 23 and the bonding film 3.

A surface treatment arbitrarily selected from the various surface treatments mentioned above is performed on the bond surface 24 so as to allow the surface 24 to have such the group or the substance, thereby being able to obtain the second base member 22 which can be strongly bonded to the bonding film 3. The bond surface 24 of the second base member 22 preferably includes the hydroxyl groups. On such the bond surface 24, large attraction force is generated based on the hydrogen bond with the bonding film 3 on which the hydroxyl groups are exposed. Accordingly, the first base member 21 and the second base member 22 can be especially strongly bonded to each other eventually. Alternatively, a surface layer may be formed in advance on the bond surface 24 of the second base member 22, instead of the surface treatment.

The surface layer can have any function, and similarly to the first base member 21, preferably has a function of increasing the adhesiveness with the bonding film 3, a cushioning function (a buffer function), a function of reducing stress concentration, and the like, for example. The second base member 22 is bonded to the bonding film 3 with the surface layer interposed therebetween, eventually, being able to obtain the bonded body 1 which is highly reliable. For example, the surface layer may be made of the same material as that of the intermediate layer formed on the bond surface 23 of the first base member 21. The surface treatment and the formation of the surface layer as above can be performed according to need and can be omitted if especially large bonding strength is not required.

[1-2] A liquid material 35 containing a silicone material is applied on the bond surface 23 of the first base member 21. Accordingly, the liquid film 30 is formed on the first base member 21 as shown in FIG. 1B. A method for applying the liquid material 35 on the bond surface 23 includes immersing, droplet discharging (ink-jetting, for example), spin coating, doctor blade, bar coating, and painting with brush. These methods may be employed singly or in a combination of two or more.

The liquid material 35 usually has a viscosity (at 25° C.) preferably approximately from 0.5 mPa·s to 200 mPa·s, and more preferably approximately from 3 mPa·s to 20 mPa·s. With the liquid material 35 having the viscosity in the above range, the liquid film 30 having even film thickness can be easily formed. Further, the liquid material 35 having the viscosity in the above range contains the silicone material in an amount necessary and sufficient for forming the bonding film 3.

In a case where the droplet discharging is employed for applying the liquid material 35 having the viscosity in the above range to the bonding film 23, an amount of a droplet (an amount of a single droplet of the liquid material 35) can be set, specifically, in a range approximately from 0.1 pL to 40 pL on an average, and more practically in a range approximately from 1 pL to 30 pL. Accordingly, since a landed diameter of a droplet applied on the bond surface 23 is small, even the bonding film 3 having a minute shape can be securely formed.

The liquid material 35 contains the silicone material as described above. However, if the silicone material is a liquid and has the viscosity in the above range, the silicone material can be used as the liquid material 35. If the silicone material is a solid or a liquid having high viscosity, a solution or a dispersion liquid of the silicone material can be used as the liquid material 35.

For example, the solvent or the dispersion medium for dissolving or dispersing the silicone material is: inorganic solvents such as ammonia, water, hydrogen peroxide, carbon tetrachloride, and ethylene carbonate; ketone solvents such as methyl ethyl ketone (MEK) and acetone; alcohol solvents such as methanol, ethanol, and isobutanol; ether solvents such as diethyl ether and diisopropyl ether; cellosolve solvents such as methyl cellosolve; aliphatic hydrocarbon solvents such as hexane and pentane; aromatic hydrocarbon solvents such as toluene, xylene, and benzene; aromatic heterocyclic solvents such as pyridine, pyrazine, and furan; amido solvents such as N,N-dimethylformamide (DMF); halogenated compound solvents such as dichloromethane and chloroform; ester solvents such as ethyl acetate and methyl acetate; sulfur compound solvents such as dimethylsulfoxide (DMSO) and sulfolane; nitrile solvents such as acetonitrile, propionitrile, and acrylonitrile; various organic solvents such as organic acid solvents including formic acid and trifluoroacetic acid; or mixtures of the solvents mentioned above.

The silicone material is contained in the liquid material 35, and is a main material for the bonding film 3 to be formed by drying the liquid material 35 in a step [3] below. Here, the “silicone material” is a compound having a polyorganosiloxane skeleton. It usually is a compound having a main skeleton (a main chain) mainly formed by repeated organosiloxane units. It may have a branched structure branched from a part of the main chain, a cyclic body that the main chain is circularly formed, or a linear-chain that the opposite terminals of the main chain are not linked to each other. For example, in the compound having the polyorganosiloxane skeleton, the organosiloxane unit includes a structural unit expressed by the following general formula (1) at a terminal portion, a structural unit expressed by the following general formula (2) at a linking portion, and a structural unit expressed by the following general formula (3) at a branched portion.

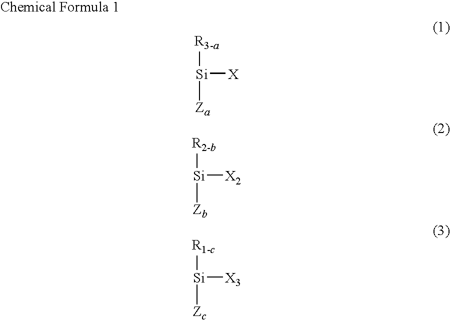

In the above formulas, each R independently represents a substituted or a non-substituted hydrocarbon group; each Z independently represents a hydroxyl group or a hydrolytic group; each X represents a siloxane residue; a represents 0 or an integer of 1 to 3; b represents 0 or an integer of 1 or 2; and c represents 0 or 1.

The siloxane residue is bonded to a silicon atom included in adjacent structure unit through an oxygen atom, and represents a substituent constituting a siloxane bond. Concretely, this structure is expressed as —O—(Si) (Si is a silicon atom included in adjacent structure unit). In the silicone material, the polyorganosiloxane skeleton preferably has a branched structure, that is, the skeleton is composed of the structural unit expressed by the general formula (1), the structural unit expressed by the general formula (2), and the structural unit expressed by the general formula (3). The compound having the branched polyorganosiloxane skeleton (hereinafter, may be referred to as a “branched compound”) has a main skeleton (a main chain) mainly formed by repeated organosiloxane units, where the repetition of the organosiloxane units is branched at a halfway portion of the main chain and opposite terminals of the main chain are not linked to each other. With the branched compound, the bonding film 3 is formed such that branch chains of the compound included in the liquid material 35 are entangled with each other in the step [2] below. Therefore, the bonding film 3 to be obtained especially has excellent film strength.

In the above general formulas (1) to (3), for example, a group indicated by R (the substituted or the non-substituted hydrocarbon group) is: alkyl groups such as a methyl group, an ethyl group, and a propyl group; cycloalkyl groups such as a cyclopentyl group and a cyclohexyl group; aryl groups such as a phenyl group, a tolyl group, and biphenyl group; or aralkyl groups such as a benzyl group and a phenyl ethyl group. Further, the R may be a group in which a part of or all of hydrogen atoms bonded to the carbon atom of these groups is substituted by: halogen atoms such as a fluorine atom, a chlorine atom, and a bromine atom; epoxy groups such as a glycidoxy group; (meta)acrylyl groups such as a methacryl group; and anionic groups such as a carboxyl group, or a sulfonyl group.

In the above general formulas (1) to (3), a group indicated by Z independently represents a hydroxyl group or a hydrolysis group. The group indicated by Z functions as a bridging group (a functional group), in which the silicone materials are cross-linked to each other, when heat is applied to the bonding film 3 in the step [3] below. Examples of the hydrolysis group include: alkoxy groups such as a methoxy group, an ethoxy group, a propoxy group, and a butoxy group; ketoxime groups such as a dimethyl ketoxime group and a methylethyl ketoxime group; acyloxy groups such as an acetoxy group; and alkenyloxy groups such as an isopropenyloxy group and an isobutenyloxy group.

The branched compound as above preferably has a silanol group. That is, in the structural units expressed by the above general formulas (1) to (3), each group indicated by Z, which is the bridging group, is preferably a hydroxyl group. Accordingly, in the following step [3] in which heat is applied to the bonding film 3, hydroxyl groups of the silanol groups included in the adjacent branched compound are more securely cross-linked (bonded) to each other. As a result, the bonding film 3 has excellent film strength, further improving solvent resistance.

Further, as described above, when the first base member 21 having hydroxyl groups exposed on the bond surface (a main surface) 23 thereof is used, the hydroxyl group of the branched compound and the hydroxyl group of the first base member 21 are bonded to each other. Thus, the branched compound can be bonded to the first base member 21 both physically and chemically. As a result, the bonding film 3 is more strongly bonded to the bond surface 23 of the first base member 21.

The branched compounds are cross-linked by a condensation reaction of two bridging groups. In a case where a hydroxyl group is selected as a group indicated by Z, moisture is generated as a side reaction product. However, the moisture can be removed by heating the bonding film 3. Accordingly, the side reaction product as an impurity can be more securely prevented from remaining in the bonding film 3. The hydrocarbon group linked to a silicon atom of the silanol group is preferably a phenyl group. Specifically, each group R in the structural units expressed by the above general formulas (1) to (3) each including a hydroxyl group as group Z is preferably a phenyl group. Accordingly, reactivity of the silanol group is further improved, further facilitating bonding between the hydroxyl groups of the adjacent branched compound in the step [3] below.

Further, the hydrocarbon group linked to the silicon atom, which is not constitute the silicon atom, is preferably a methyl group. Specifically, the group R included in the structural units expressed by the general formulas (1) to (3) having no group Z is preferably a methyl group.

The compound including a methyl group as the group R included in the structural unit expressed by each of the general formulas (1) to (3) having no group Z is relatively easily available at low cost. Further, in a step [4] below, since energy is applied to the bonding film 3, the methyl group is easily cleaved, and thereby adhesiveness is securely developed on the bonding film 3. As a result, the compound including a methyl group is preferably used as a branched compound (the silicone material). Considering from the above, a compound expressed by the following general formula (4) is preferably used as the branched compound (the silicone material), for example.

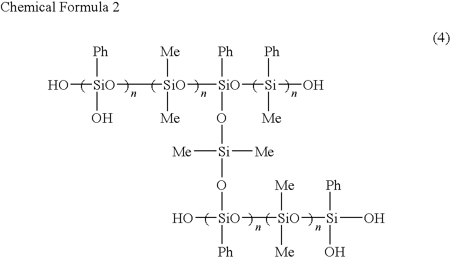

In the above formula, n each independently represents an integer of 0 or 1 or more.

In addition, the branched compound described above is a relatively flexible material. Therefore, when the bonded body is obtained by bonding the second base member 22 and the first base member 21 with the bonding film 3 interposed therebetween in the step [4] below, stress caused by thermal expansion generated between the base members 21 and 22 can be securely reduced even if the first and second base members 21 and 22 are made of different materials, for example. Accordingly, in the bonded body 1 eventually obtained, separation between the base members can be securely prevented.

The branched compound has excellent solvent resistance and thus can be effectively used to bond members exposed to solvent or the like for a long period of time. For example, in manufacturing of a droplet discharge head for an industrial inkjet printer using an organic ink apt to erode a resin material, members are bonded together with the bonding film 3 interposed therebetween, reliably improving durability of the head. Furthermore, since the branched compound has high heat resistance, the branched compound can be effectively used to bond members which are exposed to a high temperature. The branched compound preferably has a molecular weight in a range approximately from 1×10⁴ to 1×10⁶, and more preferably approximately from 1×10⁵ to 1×10⁶. By setting the molecular weight within the above range, the viscosity of the liquid material 35 can be relatively easily set within the range described above.

[2] Forming Bonding Film

The liquid material 35 applied on the first base member 21, that is, the liquid film 30 is dried. Accordingly, the bonding film 3 is formed on the first base member 21 as shown in FIG. 1C. A temperature for drying the liquid film 30 is preferably 25° C. or more, and more preferably approximately from 25° C. to 70° C.

Time for drying the liquid film 30 is preferably approximately from 0.5 hours to 48 hours, and more preferably approximately from 15 hours to 30 hours. By drying the liquid film 30 under the above condition, in the step [4] below, the bonding film 3 can be securely formed on which adhesiveness is preferably developed by applying energy thereto.

An ambient pressure in the drying process may be an atmospheric pressure, but preferably a reduced pressure. Specifically, a value of the reduced pressure ranges from preferably approximately 133.3×10⁻⁵ Pa to 1333 Pa (1×10⁻⁵ Torr to 10 Torr), and more preferably approximately from 133.3×10⁻⁴ Pa to 133.3 Pa (1×10⁻⁴ Torr to 1 Torr). Accordingly, layer density of the bonding film 3 is increased, that is, the bonding film 3 is densified so as to obtain the bonding film 3 having excellent film strength.

As described above, by arbitrarily setting the conditions for forming the bonding film 3, the bonding film 3 having desired film strength can be formed. An average thickness of the bonding film 3 is preferably in a range approximately from 10 nm to 10,000 nm, and more preferably approximately from 3000 nm to 6000 nm. Setting the average thickness of the bonding film 3 in the range by arbitrarily determining an applying amount of the liquid material 35 can prevent a significant reduction in dimensional accuracy of the bonded body obtained by bonding the first and second base members 21 and 22, and also can ensure stronger bonding of the members.

In a case where the average thickness of the bonding film 3 is smaller than the above range, sufficient bonding strength for bonding the first and the second base members 21 and 22 may not be disadvantageously obtained. On the other hand, in a case where the average thickness of the bonding film 3 is larger than the above range, the dimensional accuracy of the bonded body may be significantly disadvantageously decreased. Further, setting the average thickness of the bonding film 3 within the above range allows the film 3 to be elastic to some extent. Accordingly, in the following step [4] in which the base members 21 and 22 are bonded to each other, even if a particle or the like adheres to the bond surface 24 of the second base member 22 to be brought into contact with the bonding film 3, the bonding film 3 is bonded to the bond surface 24 in such a manner surrounding the particle or the like. This can appropriately suppress or prevent decrease in the bonding strength at an interface between the bonding film 3 and the bond surface 24 and separation occurring at the interface caused by the presence of the particle or the like.

In the embodiment, the bonding film 3 is formed by applying the liquid material 35. Accordingly, even if an uneven spot exists on the bond surface 23 of the first base member 21, the bonding film 3 can be formed so as to take up the uneven spot though depending on a height of the uneven spot. As a result, the bonding film 3 has a surface 32 which is nearly flat. The silicone materials are cross-lined by heating the bonding film 3 in the following step [3], however, part of the silicone materials may be cross-linked in obtaining the bonding film 3 by drying the liquid film 30 in the step [2].

[3] Heating

As shown in FIG. 1D, the obtained bonding film 3 is heated. Accordingly, the silicone materials contained in the bonding film 3 are cross-linked to each other. As a result, the bonding film 3 has excellent film strength, further improving solvent resistance. Since the bonding film 3 has excellent durability, the bonding film 3 used to bond members exposed to solvent or the like for a long period of time can be appropriately prevented from being altered and deteriorated by the contact of solvent or the like with the bonding film 3.

Further, as described above, when the first base member 21 having hydroxyl groups exposed on the bond surface (the main surface) 23 thereof is used, the silicone material and the hydroxyl group of the first base member 21 can be bonded by heating the bonding film 3. Thus, the silicone material can be physically and chemically bonded to the first base member 21. As a result, the bonding film 3 is more strongly bonded to the bond surface 23 of the first base member 21.

When the silicone materials are cross-linked, the bridging groups in the silicone material are cross-linked to each other. As the cross-linking proceeds, the hydrocarbon groups such as the methyl groups are preferentially exposed on the surface 32 of the bonding film 3. Therefore, when plasma is brought into contact with the surface 32 in the following step [4], more dangling bonds, generated by cleaving the hydrocarbon groups by the contact of plasma, and more hydroxyl groups can exist on the surface 32. As a result, the bonding strength between the bonding film 3 and the base member 22 at the surface 32 can be further improved.

A temperature for heating the bonding film 3 is not limited to a specific value as long as it is higher than a temperature for drying the liquid film 30. However, the heating temperature is preferably in a range approximately from 80° C. to 250° C., and more preferably approximately from 120° C. to 180° C. Time for heating the bonding film 3 is preferably approximately from 0.2 hours to 15 hours, and more preferably approximately from 0.5 hours to 5 hours.

By heating the bonding film 3 under the above condition, solvent resistance of the bonding film 3 can more securely be enhanced, and in the step [4] below, the bonding film 3, on which adhesiveness is preferably developed by applying energy, can be obtained. An ambient pressure in heating the bonding film 3 may be an atmospheric pressure, but preferably a reduced pressure as drying the liquid film 30. A value of the reduced pressure is set in the same manner as drying the liquid film 30. Accordingly, the whole of the bonding film 3 is evenly heated, so that the cross-linking of the silicone materials is evenly performed on the whole of the bonding film 3.

In the present embodiment, the step [3] is performed prior to the formation of the bonded body 1 in the following step [4]. However, as to be described in a second embodiment, the step [3] may be performed after the formation of the bonded body 1. In the second embodiment in which the bonding film 3 is heated after the formation of the bonded body, however, problems as described below may occur.

That is, in a case where the thermal expansion coefficients of the first and the second base members 21 and 22 are different from each other, heat stress may be generated at the bonded interface by heating the bonded body 1 depending on conditions, such as a difference of the thermal expansion coefficients of the first and the second base members 21 and 22 and a temperature for heating the bonding film 3. Due to this heat stress, warpage of the bonded body 1, which is cooled down, or separation at the bonding surface may occur. Further, the silicone materials contained in the bonding film 3 are cross-linked by heating the bonding film 3. However, air bubbles (outer gas) may be generated by the cross-linking of the silicone material depending on kinds of the silicone material to be used. As a result, the air bubbles remain in the bonded body 1, decreasing the bonding strength of the bonded body 1.

On the other hand, as described in the present embodiment, the bonding film 3 formed on the first base member is heated without being bonded to the second base member 22. Accordingly, heat stress occurring at the bonded interface of the bonded body 1 can be securely prevented. Further, even if air bubbles are generated, the air bubbles can be easily emitted to the outside of the bonding film 3. Thus, is possible to solve the problems occurring when the bonding film 3 is heated after the formation of the bonded body 1 with ease.

[4] Forming Bonded Body

[4-1] Energy is applied to the surface 32 of the bonding film formed 3 on the bond surface 23. Due to the application of energy to the bonding film 3, part of molecular bonds around the surface 32 is cleaved in the bonding film 3, whereby activating the surface 32. As a result, adhesiveness with the second base member 22 is developed around the surface 32.

The first base member 21 in such the state can be strongly bonded to the second base member 22 based on chemical bonding. Here, in this specification, a state that the surface 32 is “activated” is the following states: a state in which part of the molecular bond of the surface 32 of the bonding film 3, specifically the methyl groups included in a polydimethylsiloxane skeleton, are cleaved, for example, and unterminated bonds (also referred to as the “free bonds” or the “dangling bonds”) occurs on the bonding film 3; a state in which the free bond is terminated by the hydroxyl group (an OH group); and a state that the above two states are mixed together.

Any method can be used for applying energy to the bonding film 3. Examples of the method include bringing plasma into contacting with the bonding film 3, irradiating the bonding film 3 with energy rays, heating the bonding film 3, applying pressure (physical energy) on the bonding film 3, exposing the bonding film 3 to ozone gas (applying chemical energy), or the like. Accordingly, the surface of the bonding film 3 can be activated.

Among the method above, bringing plasma into contact with the bonding film 3 is preferably used for applying energy to the bonding film 3. The method allows energy to be relatively easily applied to the bonding film 3 and to be selectively applied around the surface 32, and thus is used as a suitable energy application method. The method for applying energy to the target object, irradiating the target object with energy rays, such as light, electromagnetic rays, electron beams, and particle beams, is generally used. However, in a case where ultraviolet rays are used as energy rays for activating the surface 32 of the bonding film 3 in the embodiment, the following problems occur.

It takes long time to activate the surface 32 of the bonding film 3 (one minute to dozens of minutes, for example). In a case of short-time irradiation of ultraviolet rays, long time (dozens of minutes or more) is required for bonding the first base member 21 and the second base member 22 in the bonding process of the members. That is, it takes long time to obtain the bonded body 1. Further, in a case of using ultraviolet rays, the ultraviolet rays easily pass through the bonding film 3 in a thickness direction. Therefore, an interface (a contacting face) between a member (the first base member 21 in the embodiment) and the bonding film 3 is deteriorated depending on a material (a resin material, for example) of the member, whereby the bonding film 3 is easily separated from the member.

The ultraviolet rays act on the whole of the bonding film 3 when passing through the bonding film 3 in the thickness direction, so that the methyl group included in the polydimethylsiloxane skeleton, for example, are cleaved and removed from the whole of the bonding film 3. That is, an amount of organic components in the bonding film 3 is excessively decreased, and conversion into an inorganic component proceeds. Accordingly, flexibility, which is produced by the organic components, of the bonding film 3 is decreased as a whole, so that intra-layer separation of the bonding film 3 easily occurs in the bonded body 1 to be obtained.

Furthermore, in a case where the first base member 21 is separated from the second base member 22 in the bonded body 1, which is obtained, so as to recycle or reuse each of the members 21 and 22, the members 21 and 22 can be separated by applying separation energy to the bonded body 1. At this time, the methyl groups (the organic components) left in the bonding film 3 are cleaved and removed from the polydimethylsiloxane skeleton, for example, and the cleaved organic component becomes gas. The gas (a gaseous organic component) produces cleavage in the bonding film 3 so as to split the bonding film 3.

However, the conversion into an organic component proceeds in the whole of the bonding film 3 in a case of the ultraviolet irradiation. Therefore, even if the separation energy is applied to the bonded body 1, extremely small amount of the organic component becomes gas, hardly producing cleavage in the bonding film 3. On the other hand, by bringing plasma into contact with the surface 32 for activating the surface 32 of the bonding film 3, a part of the molecular bonds of the material of the bonding film 3, for example the methyl groups included in the polydimethylsiloxane skeleton, are selectively cleaved around the surface 32 of the bonding film 3.

The cleaving of molecular bonds by plasma occurs by physical acting based on penning effect of the plasma as well as chemical acting based on electric charge of the plasma. Therefore, the cleaving occurs in extremely short time. Accordingly, the bonding film 3 can be activated in an extremely short period of time (a few seconds, for example). As a result, the bonded body 1 can be manufactured in a short period of time. Further, the plasma selectively acts on the surface 32 of the bonding film 3, and thus hardly affects the inside of the bonding film 3. Therefore, the molecular bonds are selectively cleaved around the surface 32 of the bonding film 3. That is, a part around the surface 32 of the bonding film 3 is selectively activated. Accordingly, disadvantages, described above, which arise in a case of activating the bonding film 3 with the ultraviolet rays hardly occurs.

As described above, the intra-layer separation of the bonding film 3 hardly occurs in the bonded body 1 in the case of using plasma for activating the bonding film 3. Therefore, the first base member 21 can be reliably separated from the second base member 22 in the separation operation. In a case of activating the bonding film 3 by the ultraviolet irradiation, an activating degree, which depends on an intensity of the ultraviolet ray with which the bonding film 3 is irradiated, of the bonding film 3 varies enormously. Therefore, in order to activate the bonding film 3 to an extent suitable for bonding the first base member 21 and the second base member 22, strict control of conditions for the ultraviolet irradiation are required. Without the strict control of conditions, the bonding strength between the first base member 21 and the second base member 22 varies in the bonded body 1 to be obtained.

On the other hand, in a case of activating the bonding film 3 by plasma, an activating degree, which depends on density of the plasma brought into contact with the bonding film, of the bonding film 3 moderately varies. Therefore, strict control of conditions for producing the plasma are not required for activating the bonding film 3 to an extent suitable for bonding the first base member 21 and the second base member 22. In other words, an acceptable range of the conditions for manufacturing the bonded body 1 is wide in a case where plasma is used for activating the bonding film 3. Even without the strict control of the conditions, the bonding strength between the first base member 21 and the second base member 22 hardly varies in the bonded body 1 to be obtained.

Further, the case of activating the bonding film 3 by the ultraviolet irradiation has such a problem that the bonding film 3 itself constricts (especially, decrease in the film thickness) as the bonding film 3 is activated, that is, as an organic substance in the bonding film 3 is eliminated. If the bonding film 3 constricts, it becomes difficult to bond the first base member 21 and the second base member 22 with high bonding strength.

On the other hand, in the case of activating the bonding film 3 by plasma, the portion around the surface of the bonding film 3 is selectively activated as described above, so that the bonding film 3 hardly constricts or does not constrict. Accordingly, even if the bonding film 3 is formed to have a relatively thin thickness, the first base member 21 and the second base member 22 can be bonded with high bonding strength. In this case, such the bonded body 1 can be obtained that has high dimensional accuracy and is thinned. As described above, the case of activating the bonding film 3 by plasma has more advantages than the case of activating the bonding film 3 by ultraviolet rays.

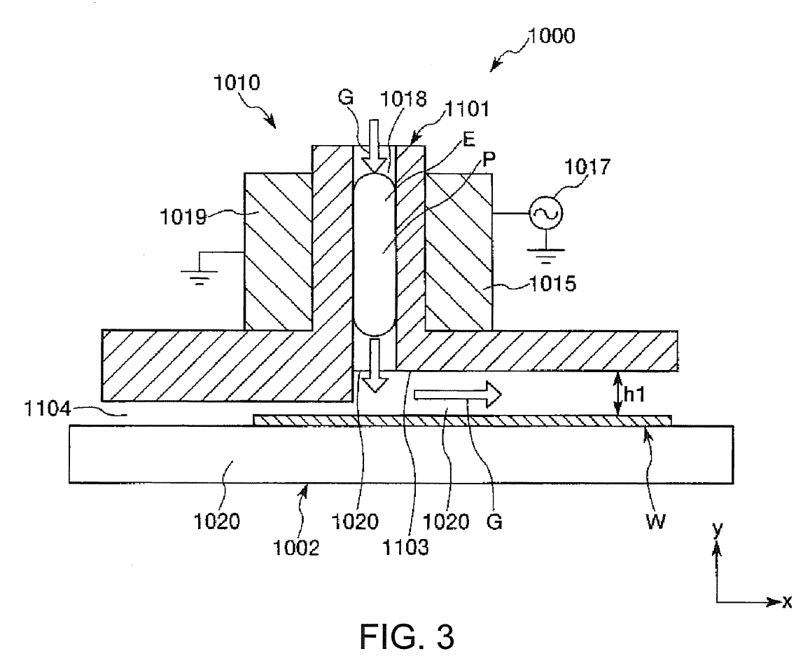

Plasma may be brought into contacted with the bonding film 3 in reduced pressure, but it is preferably performed in atmospheric pressure. That is, the bonding film 3 is preferably treated by atmospheric-pressure plasma. According to the atmospheric-pressure plasma treatment, a surrounding area of the bonding film 3 does not become a reduced pressure state. Therefore, when the methyl groups included in the polydimethilsiloxane skeleton, for example, are cleaved and removed (in the activation of the bonding film 3), the plasma acts to prevent unwanted progress of the cleaving. The plasma treatment in the atmospheric pressure can be performed with an atmospheric-pressure plasma treatment apparatus shown in FIG. 3, for example.

FIG. 3 is a schematic view showing a structure of an atmospheric-pressure plasma apparatus. An atmospheric-pressure plasma apparatus 1000 shown in FIG. 3 includes a conveying device 1002 conveying the first base member 21 (hereinafter, simply referred to as a “treated substrate W”) on which the bonding film 3 is formed and a head 1010 disposed above the conveying device 1002. In the atmospheric-pressure plasma device 1000, a plasma generation region P in which plasma is generated is formed between an applying electrode 1015 and a counter electrode 1019 that are included in the head 1010. Hereinafter, a structure of each component will be described.

The conveying device 1002 includes a moving stage 1020 which is capable of carrying the treated substrate W. The moving stage 1020 can be moved in an x-axis direction by an operation of a moving unit (not shown) included in the conveying device 1002. Here, the moving stage 1020 is made of a metal material such as stainless steel and aluminum, for example.

The head 1010 includes a head body 1101, the applying electrode 1015, and the counter electrode 1019. In the head 1010, a gas supply flow path 1018 for supplying a treatment gas G which is converted into plasma to a gap 1102 formed between an upper surface of the moving stage 1020 (the conveying device 1002) and a lower surface 1103 of the head 1010.

The gas supply flow path 1018 is opened at an opening 1181 formed in the lower surface 1103 of the head 1010. Further, a step is formed at the left side, in the drawing, of the lower surface 1103, as shown in FIG. 3. Accordingly, a gap 1104 formed between the left side portion, in the drawing, of the head body 1101 and the moving stage 1020 is smaller (narrower) than the gap 1102. As a result, entering of the treatment gas G, which is converted into plasma, to the gap 1104 is suppressed or prevented, so that the treatment gas G preferentially flows in an x-axis positive direction.

The head body 1101 is made of, for example, a dielectric material such as alumina and quartz. In the head body 1101, the applying electrode 1015 and the counter electrode 1019 are oppositely disposed so as to sandwich the gas supply flow path 1018, thus forming a pair of parallel plate electrodes. The applying electrode 1015 is electrically coupled to a high frequency power supply 1017, and the counter electrode 1019 is grounded. The applying electrode 1015 and the counter electrode 1019 are made of, for example, a metal material such as stainless steel and aluminum.

In a case of performing the plasma treatment on the treated substrate W, a voltage is applied between the applying electrode 1015 and the counter electrode 1019 by the atmospheric-pressure plasma apparatus 1000 so as to generate an electric field E. In this state, the treatment gas G is flown into the gas supply flow path 1018. At this time, the treatment gas G flowing into the gas supply flow path 1018 is converted into plasma by acting of the electric field E. The treatment gas G which is converted into plasma is supplied into the gap 1102 from the opening 1181 formed on the lower surface 1103. Accordingly, the treatment gas G which is converted into plasma is brought into contact with the surface 32 of the bonding film 3 formed on the treated substrate W. Thus the plasma treatment is performed.

Thus, by using the atmospheric-pressure plasma apparatus 1000 described above, the bonding film 3 can be easily and securely activated by bringing plasma into contact with the bonding film 3. Here, a distance between the applying electrode 1015 and the moving stage 1020 (the treated substrate W), that is, a height of the gap 1102 (a length denoted by hl in FIG. 3) is arbitrarily determined in consideration of an output of the high frequency power supply 1017, a kind of the plasma treatment performed on the treated substrate W, and the like. However, the distance is preferably in a range approximately from 0.5 mm to 10 mm, and more preferably approximately from 0.5 mm to 2 mm. Accordingly, the bonding film 3 can be securely activated by bringing plasma into contact with the bonding film 3.

Further, the voltage applied between the applying voltage 1015 and the counter electrode 1019 is preferably in a range approximately from 1.0 kVp-p to 3.0 kVp-p, and more preferably approximately from 1.0 kVp-p to 1.5 kVp-p. Accordingly, the electric field E can be more securely generated between the applying electrode 1015 and the moving stage 1020 so as to securely convert the treatment gas G supplied to the gas supply flow path 1018 into plasma.

A frequency of the high frequency power supply 1017 is not particularly limited, but is preferably in a range approximately from 10 MHz to 50 MHz, and more preferably approximately from 10 MHz to 40 MHz. The treatment gas G is not particularly limited, but may be a rare gas such as a helium gas and an argon gas, and an oxygen gas, for example. These gases can be used singly or used in a combination of two or more. Among these, the treatment gas G is preferably a gas mainly containing a rare gas, and especially preferably a gas mainly containing a helium gas.

That is, plasma used for the treatment is preferably obtained by converting a gas mainly containing a helium gas into plasma. The gas mainly containing a helium gas (the treatment gas G) hardly generates ozone when converted into plasma, so that alteration (oxidation), caused by ozone, of the surface 32 of the bonding film 3 can be prevented. As a result, decrease in activating degree of the bonding film 3 can be prevented, that is, the bonding film 3 can be securely activated. Further, plasma of the helium gas is favorably used from such a viewpoint that the plasma of the helium gas exhibits substantially high penning effect described above so as to be capable of securely activating the bonding film 3 in a short period of time.

In this case, a supplying speed of the gas mainly containing a helium gas to the gas supply flow path 1018 is preferably in a range approximately from 1 SLM to 20 SLM, and more preferably approximately from 5 SLM to 15 SLM. Accordingly, the extent of activation of the bonding film 3 is easily controlled. A contained amount of the helium gas in the gas (the treatment gas G) is preferably 85 vol % or more, and more preferably 90 vol % or more (can be 100%). Accordingly, the effect described above can be more markedly exhibited. A moving speed of the moving stage 1020 is not particularly limited, but is preferably in a range approximately from 1 mm/sec. to 20 mm/sec., more preferably approximately from 3 mm/sec. to 6 mm/sec. The bonding film 3 can be sufficiently and securely activated by bringing the plasma into contact with the bonding film 3 at such the speed even in a short period of time.

[4-2] The first base member 21 and the second base member 22 are superposed in a manner that the bonded film 3 is closely brought into contact with the second base member 22 (refer to FIG. 2F). Since the adhesiveness with the second base member 22 is developed on the surface 32 of the bonding film 3 in the step [4-1] above, the bonding film 3 and the bond surface 24 of the second base member 22 are chemically bonded to each other. As a result, the first base member 21 and the second base member 22 are bonded together with the bonding film 3 interposed therebetween, whereby the bonded body 1 as shown in FIG. 2G is obtained.

Such the bonding method does not require a thermal treatment at high temperature (for example, 700° C. or higher), so that the first base member 21 and the second base member 22 that are made of a material having low thermal resistance can be bonded together. Since the first base member 21 and the second base member 22 are bonded to each other with the bonding film 3 interposed therebetween, a material for each of the base members 21 and 22 is not limited. As described above, in the embodiment, a material for each of the first base member 21 and the second base member 22 has a wide range of choices.

In a case where the first base member 21 and the second base member 22 have different thermal expansion coefficients from each other, they are preferably bonded at the lowest possible temperature. Bonding at a low temperature further reduces thermal stress occurring at the bonded interface. Specifically, though it depends on a difference between the thermal expansion coefficients of the first base member 21 and the second base member 22, the first base member 21 and the second base member 22 are preferably bonded to each other under a state that a temperature of the first base member 21 and the second base member 22 is in a range approximately from 25° C. to 50° C., and more preferably approximately from 25° C. to 40° C. With such the temperature range, even if a difference between the thermal expansion coefficients of the first base member 21 and the second base member 22 is large to some extent, thermal stress occurring at the bonded interface can be sufficiently reduced. As a result, warpage or separation occurring in the bonded body 1 can be securely suppressed or prevented.

In a case where a difference between the thermal expansion coefficients of the first base member 21 and the second base member 22 is specifically 5×10⁻⁵/K or more, the base members are especially recommended to be bonded at the lowest possible temperature as above. Here, a mechanism for bonding the first base member 21 and the second base member 22 in this step will be described.

As an example, a case where the hydroxyl groups are exposed on the bond surface 24 of the second base member 22 will be explained. In the present step, when the bonding film 3 formed on the first base member 21 and the bond surface 24 of the second base member 22 are superposed so as to contact with each other, the hydroxyl groups existing on the surface 32 of the bonding film 3 and the hydroxyl groups existing on the bond surface 24 of the second base member 22 attract each other by a hydrogen bond so as to generate attraction force between the hydroxyl groups. It is assumed that the first base member 21 and the second base member 22 are bonded together other by this attraction force.

The hydroxyl groups attracting each other by the hydrogen bond are cleaved from the surfaces with dehydration condensation depending on a temperature condition and the like. As a result, at a contact interface between the first base member 21 and the second base member 22, unterminated bonds, from which the hydroxyl groups are cleaved, are bonded to each other. Accordingly, it is assumed that the first base member 21 and the second base member 22 are more strongly bonded. If the unterminated bonds or the free bonds (the dangling bonds) exist at the surface or the inside of the bonding film 3 of the first base member 21 and the bond surface 24 or the inside of the second substrate 22, these free bonds are rebonded when the first substrate 21 and the second substrate 22 are bonded to each other. The free bonds are complexly rebonded in a manner overlapping (intertangling) each other, whereby a bond of a network-like is formed on the bonded interface. Accordingly, the bonding film 3 and the second base member 22 are especially strongly bonded.

The activated state of the surface of the bonding film 3 activated in the step [4-1] above is temporally reduced. Therefore, the present step [4-2] is preferably performed as soon as possible after the completion of the previous step [4-1]. Specifically, the step [4-2] is preferably performed within 60 minutes after the completion of the step [4-1], and more preferably within 5 minutes. Within the time above, the surface of the bonding film 3 keeps the sufficient activated state. Therefore, when the first base member 21 and the second base member 22 are bonded together, sufficient bonding strength can be obtained between the members.

In other words, the bonding film 3 prior to the activation is a bonding film obtained by drying the silicone material, so that it is relatively chemically stable and has excellent weather resistance. Accordingly, the bonding film 3 prior to the activation is suitable for a long term storage. Therefore, a large amount of the first base members 21 having such the bonding film 3 may be manufactured or purchased and stored. Then, immediately before the bonding process of the present step, only a required number of the first base members 21 are heated so as to cross-link the silicone materials as described in the step [3] above and energy is applied as described in the step [4] above. This is beneficial from viewpoints of manufacturing efficiency of the bonded body 1.

In obtaining the bonded body 1, if necessary, the bonded body 1 may be pressurized so that the first base member 21 and the second base member come close to each other. Accordingly, the bonding strength of the bonded body 1 can be enhanced with ease. The pressure may be arbitrarily adjusted in accordance with the material and the thickness of each of the first base member 21 and the second base member 22, conditions of a bonding device, and the like. Specifically, though it slightly varies depending on the material and the thickness of each of the first base member 21 and the second base member 22, the pressure is preferably in a range approximately from 5 MPa to 60 MPa, and more preferably approximately from 20 MPa to 50 MPa. Accordingly, the bonding strength of the bonded body 1 is reliably increased. The pressure may exceed the above range. However, in this case, the first base member 21 and the second base member 22 may be damaged, for example, depending on the material thereof.

Pressurizing time is not particularly limited, but it is preferably in a range approximately from 10 seconds to 30 minutes. Here, the pressurizing time may be arbitrarily changed depending on pressure to be applied. Specifically, as the pressure applied on the bonded body 1 is higher, the bonding strength of the bonded body 1 can be improved even if the pressurizing time is short. As above, the bonded body (the bonded body of the invention) 1 shown in FIG. 2G can be obtained.

In the bonded body 1 thus formed, the bonding strength between the base member 21 and the second base member 21 is preferably 5 MPa (50 kgf/cm²) or more, and more preferably 10 MPa (100 kgf/cm²) ore more. In the bonded body 1 having the above bonding strength, separation between the base members can be sufficiently prevented. In addition, according to the bonding method of the embodiment, the bonded body 1 in which the first base member 21 and the second base member 22 are bonded to each other with large bonding strength as above can be efficiently manufactured. Further, according to the bonding method of the embodiment, since the silicone materials contained in the bonding film 3 are cross-linked to each other, the bonding film 3 has excellent solvent resistance. Therefore, even if the bonding film 3 is used to bond members exposed to solvent or the like for a long period of time, the bonding film 3 can be appropriately prevented from being altered and deteriorated.

### Second Embodiment

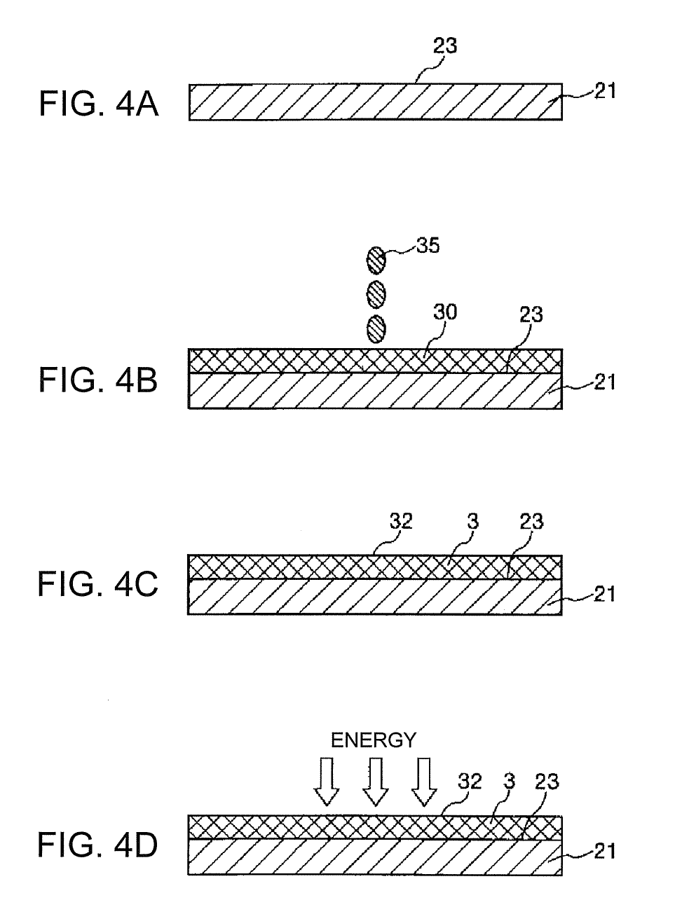

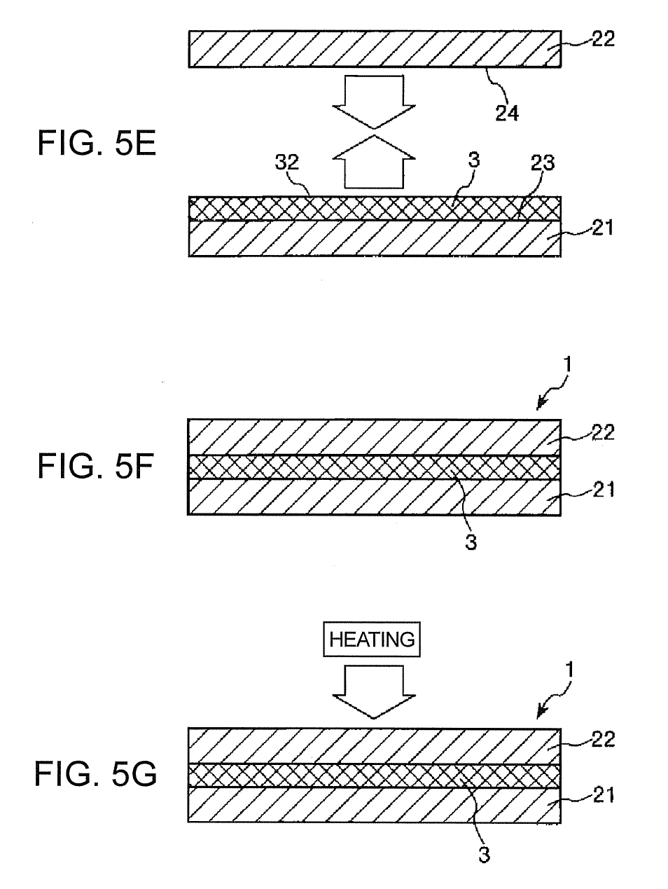

A bonding method according to a second embodiment of the invention will now be described. FIGS. 4A to 5G are diagrams (vertical sectional views) for explaining the second embodiment exemplifying the bonding method of the invention. In the following description, the upper side in FIGS. 4A to 5G is described as “upper” while the lower side is described as “lower.” In the description of the bonding method of the second embodiment, points different from those in the bonding method of the first embodiment will be focused on, and description of the same contents will be omitted. In the bonding method according to the present embodiment, the bonding film 3 is heated after the formation of the bonded body 1 in which the first base member 21 and the second base member are bonded with the bonding film 3 interposed therebetween. Besides that, the bonding method is the same as that in the first embodiment.

In other words, the bonding method of the present embodiment includes the following steps: [1′] preparing the first base member 21 and the second base member 22 that are to be bonded to each other with a bonding film interposed therebetween, and applying the liquid material containing a silicone material to the first base member 21 so as to form the liquid film 30, [2′] drying the liquid film so as to obtain the bonding film 3 on the first base member 21, [3′] applying energy to the bonding film 3 so as to develop adhesiveness around the surface of the bonding film 3 so as to obtain the bonded body 1 in which the first base member 21 and the second base member 22 are bonded to each other with the bonding film 3, on which the adhesiveness is developed, interposed therebetween, and [4′] heating the bonding film 3 so as to cross-link the silicone materials contained in the bonding film 3 to each other.

[1′] The first base member 21 and the second base member 22 similar to those in the step [1-1] above are first prepared. As shown in FIG. 4B, the liquid film 30 is formed on the first base member 21 in the same manner as the steps [1-2] and [1-3] above. [2′] As shown in FIG. 4C, the liquid film 30 is dried so as to form the bonding film 3 on the first base member 21 in the same manner as the step [2] above.

[3′] As shown in FIG. 4D, energy is applied to the bonding film 3 so as to develop adhesiveness around the surface 32 of the bonding film 3 in the same manner as the step [4-1] above. Then, as shown in FIG. 5E, the first base member 21 and the second base member 22 are superposed in a manner that the second base member is closely brought into contact with the bonded film 3, on which the adhesiveness is developed. Accordingly, the first base member 21 and the second base member 22 are bonded to each other with the bonding film 3 interposed therebetween, whereby the bonded body 1 as shown in FIG. 5F is obtained.

[4′] As shown in FIG. 5G, the bonding film 3 is heated so that the silicone materials contained in the bonding film 3 are cross-linked to each other in the same manner as the step [3] above. Accordingly, the bonding film 3 has excellent film strength, and solvent resistance is further improved. Through the above process, the bonded body 1 can be obtained.

In a case where the bonded body 1 is obtained through the process above, the silicone materials contained in the bonding film 3 are cross-linked to each other. Therefore, the bonding film 3 has excellent solvent resistance. As a result, even if the bonding film 3 is used to bond members exposed to solvent or the like for a long period of time, the bonding film 3 can be appropriately prevented from being altered and deteriorated.

### Third Embodiment

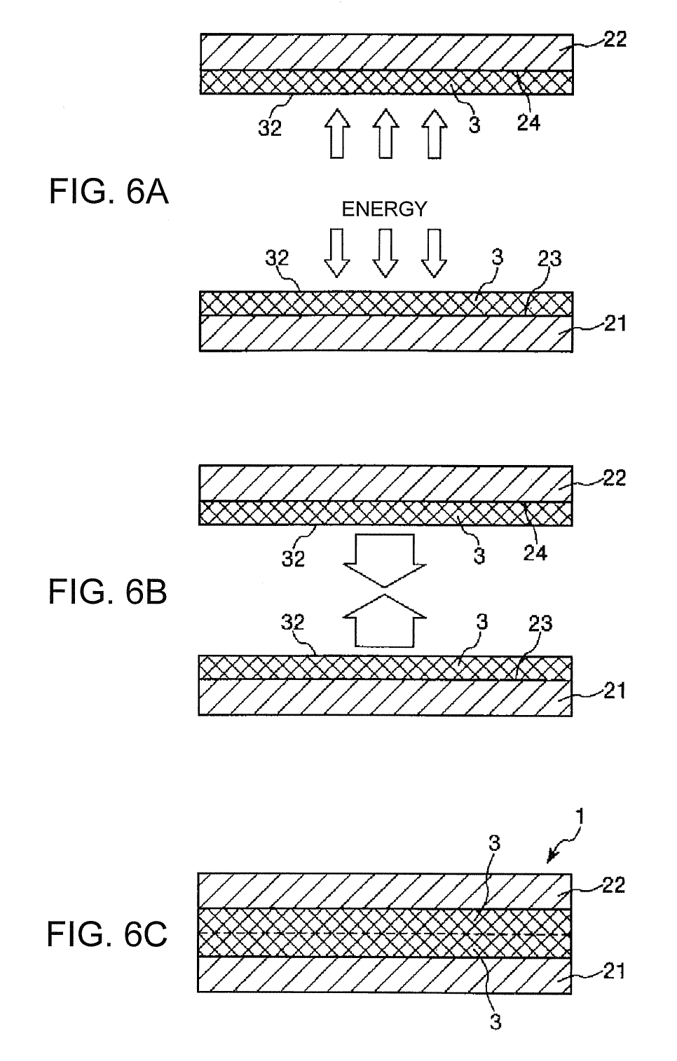

A bonding method according to a third embodiment of the invention will now be described. FIGS. 6A to 6C are diagrams (vertical sectional views) for explaining the bonding method of the third embodiment. In the following description, the upper side of FIGS. 6A to 6C is described as “upper” while the lower side is described as “lower.” In the description of the bonding method of the third embodiment, points different from those in the bonding method of the first and the second embodiments will be focused on, and description of the same contents will be omitted.

In the bonding method according to the embodiment, the bonding film 3 is formed not only on the bond surface (the main surface) 23 of the first base member 21 but also on the bond surface (the main surface) 24 of the second base member 22. Adhesiveness is developed around the main surfaces 32 of the bonding films 3 provided to the base members 21 and 22, and the bonding films 3 are brought into contact with each other. Thus, the first base member 21 and the second base member 22 are bonded to each other, providing the bonded body 1. The bonding process except for the above is the same as that of the first embodiment.

In other words, the bonding method of the present embodiment includes the following steps: [1″] preparing the first base member 21 and the second base member 22 that are to be bonded to each other with a bonding film interposed therebetween, and applying a liquid material containing a silicone material to the first base member 21 and the second base member so as to form the liquid films 30, [2″] drying the liquid film so as to the bonding films 3 on each of the first base member 21 and the second base member 22, [3″] heating the bonding films 3 so as to cross-link the silicone materials contained in the bonding films 3 to each other, and [4″] applying energy to each of the bonding films 3 so as to develop adhesiveness around the surfaces of the bonding films 3, and bringing the bonding films 3, on which the adhesiveness is developed, into contact with each other so as to obtain the bonded body 1 in which the first base member 21 and the second base member 22 are bonded together.

[1″] The first base member 21 and the second base member 22 similar to those in the step [1-1] above are first prepared. As shown in FIG. 4B, the liquid film 30 is formed on the first base member 21 in the same manner as the steps [1-2] and [1-3] above, and the liquid film 30 is also formed on the bond surface 24 of the second base member as well. [2″] The liquid films 30 are dried in the same manner as the step [2] above so as to form the bonding films 3 on each of the first base member 21 and the second base member 22. [3″] The bonding films 3 formed on the first base member 21 and the second base member 22 are both heated in the same manner as the step [3] above so that the silicone materials contained in the bonding films 3 are cross-linked to each other. As a result, solvent resistance of the bonding films 3 is further improved.

[4″] As shown in FIG. 6A, energy is applied in the same manner as the step [4-1] above to both of the bonding films 3 formed on the first base member 21 and the second base member 22 so as to develop adhesiveness around the surface 32 of each of the bonding films 3. Thereafter, as shown in FIG. 6B, the first base member 21 and the second base member 22 are bonded to each other in a manner that the bonding films 3, on which the adhesiveness is developed, are closely brought into contact with each other in the same manner as the step [4-2] above. As a result, the base members 21 and 22 are bonded to each other with the bonding films 3 formed on each of the base members 21 and 22, whereby the bonded body 1 as shown in FIG. 6C is obtained. Through the above process, the bonded body 1 can be obtained.

In the first, second, and third embodiments described above, the bonding film 3 is formed entirely on the surface of one base member and both surfaces of the first and second base members 21 and 22. However, the bonding film 3 may be selectively formed on a part of one surface or parts of both surfaces of the first and the second base members 21 and 22. In this case, a region in which the first base member 21 and the second base member 22 are bonded together can be easily determined by only arbitrarily setting a size of a region on which the bonding film 3 is formed. Accordingly, the bonding strength of the bonded body 1 can be easily adjusted by controlling an area or a shape of the bonding film 3 to which the first and the second base members 21 and 22 are bonded, for example. Consequently, the bonded body 1 from which the bonding film 3 is easily separated, for example, can be obtained.

That is, the bonding strength of the bonded body 1 can be adjusted, and strength for splitting the bonded body 1 (splitting strength) can be adjusted at the same time. In this regard, when manufacturing the bonded body 1 that can be easily split, the bonding strength of the bonded body 1 is preferably set to such an extent that the bonded body 1 can be easily split by human hands. Accordingly, the bonded body 1 can be easily split without using a device or the like.

Further, local concentration of stress occurring at the bonding film 3 can be reduced by arbitrarily setting an area and a shape of the bonding film 3 to which the first and the second base members 21 and 22 are bonded. Accordingly, even if a difference between the thermal expansion coefficients of the first base member 21 and the second base member 22 is large for example, the base members 21 and 22 can be securely bonded. Further, in this case, a space having a size (height) corresponding to the thickness of the bonding film 3 is formed between the first base member 21 and the second base member 22 in a region 42 in which the bonding film 3 is not formed (film non-forming region). In order to utilize the space, a closed space or a flow path can be formed between the first base member 21 and the second base member 22 by arbitrarily adjusting a shape of a region on which the bonding film 3 is formed (film forming region).

Droplet Discharge Head

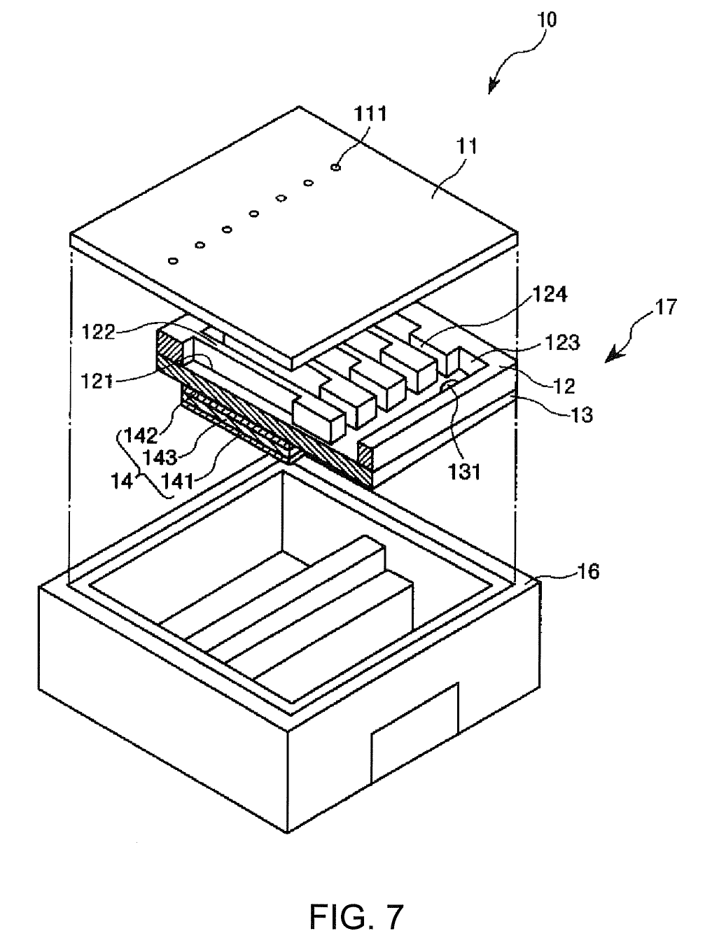

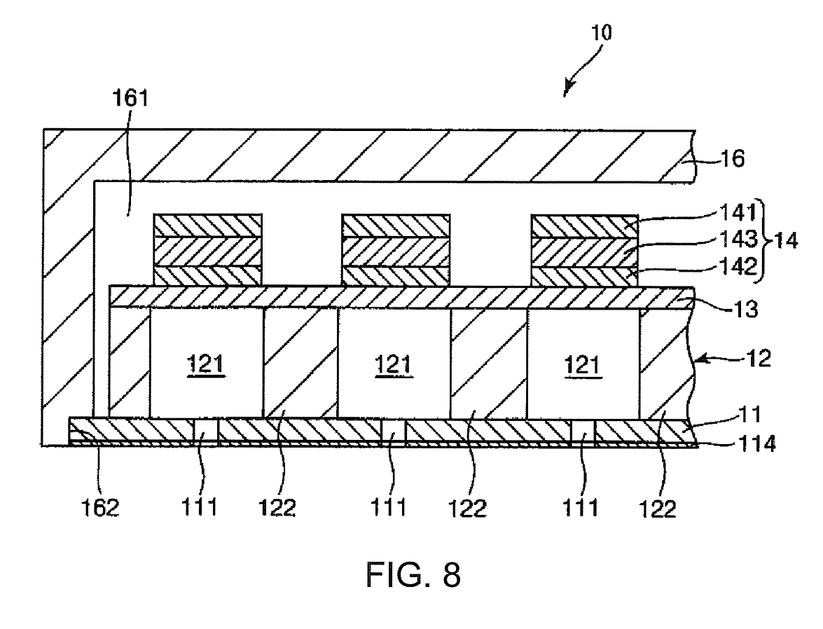

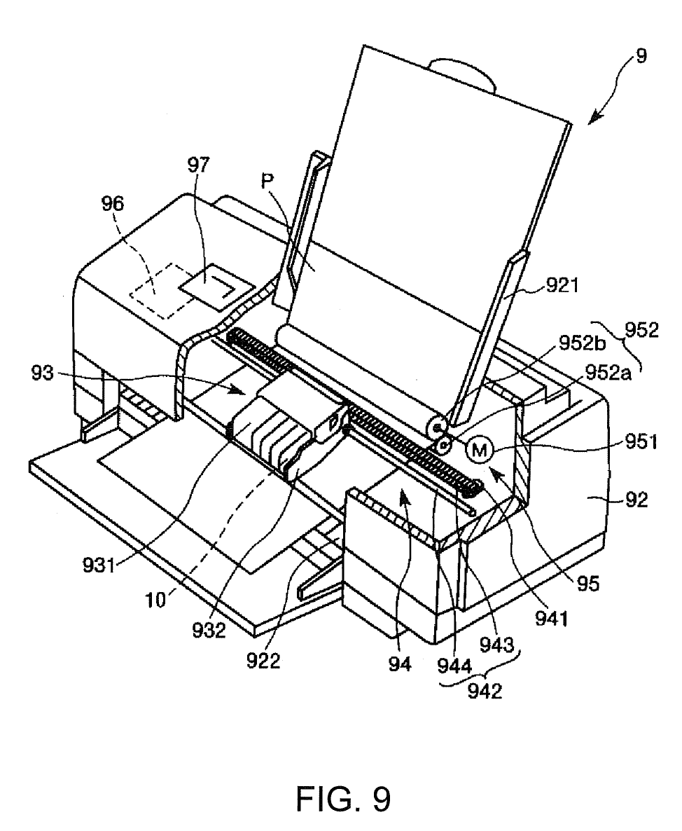

An inkjet type recording head produced by applying the bonded body of any of the embodiments will be described. FIG. 7 is an exploded perspective view showing an inkjet type recording head (a droplet discharge head) obtained by applying the bonded body of the embodiments. FIG. 8 is a sectional view showing a structure of a main part of the inkjet type recording head of FIG. 7. FIG. 9 is a schematic view showing an inkjet printer, according to the embodiment, including the inkjet type recording head of FIG. 7. In FIG. 7, the inkjet type recording head is shown upside down relative to its normal operative position.

An inkjet type recording head 10 shown in FIG. 7 is mounted on an inkjet printer 9 as shown in FIG. 7. The inkjet printer 9 shown in FIG. 9 includes a device body 92; a tray 921 for placing a record paper P at the upper rear of the device body 92; a paper discharging port 922 for discharging the record paper P at the lower front of the device body 92; and an operation panel 97 provided on an upper surface of the device body 92.

For example, the operation panel 97 includes: a display section (not shown) composed of a liquid crystal display, an organic EL display, an LED lamp, or the like and displaying an error message and the like; and an operating section (not shown) composed of various kinds of switches and the like. Inside the device body 92 are mainly provided a printing device (a printing unit) 94 having a reciprocating head unit 93, a paper feeding device (a paper feeding unit) 95 feeding each sheet of the record paper P into the printing device 94, and a controlling section (a controlling unit) 96 controlling the printing device 94 and the paper feeding device 95.

The controlling section 96 controls the paper feeding device 95 to intermittently feed each sheet of the recording paper P. The recording paper P passes through near the lower part of the head unit 93. During the passing of the record paper P, the head unit 93 reciprocates in a direction approximately orthogonal to a direction for feeding the record paper P to perform printing on the record paper P. In short, inkjet printing is performed in a manner that reciprocation of the head unit 93 and the intermittent feeding of the record paper P correspond to main scanning and sub-scanning respectively in a printing operation.

The printing device 94 includes the head unit 93, a carriage motor 941 as a driving source for the head unit 93, and a reciprocation mechanism 942 reciprocating the head unit 93 corresponding to rotation of the carriage motor 941. At the lower part of the head unit 93 are provided an inkjet recording head 10 (hereinafter, simply referred to as a “head 10”) having a multitude of nozzle holes 111, an ink cartridge 931 supplying ink to the head 10, and a carriage 932 having the head 10 and the ink cartridge 931 mounted thereon.

Here, the ink cartridge 931 includes four color ink cartridges (yellow, cyan, magenta, and black), enabling full-color printing. The reciprocation mechanism 942 includes a carriage guiding shaft 944 having end portions supported by a frame (not shown) and a timing belt 943 extending in parallel with the carriage guiding shaft 944.

The carriage 932 is reciprocatably supported by the carriage guiding shaft 944 and fixed to a part of the timing belt 943. With an operation of the carriage motor 941, the timing belt 943 runs forward and backward via pulleys, whereby the head unit 93 is guided by the carriage guiding shaft 944 to perform reciprocating motion. During the reciprocation, the head 10 arbitrarily discharges ink to perform printing on the record paper P. The paper feeding device 95 includes a paper feeding motor 951 as a driving source for the paper feeding device 95 and a paper feeding roller 952 rotating in a manner to correspond to an operation of the paper feeding motor 951.

The paper feeding roller 952 is composed of a driven roller 952a and a driving roller 952b that are disposed to be vertically opposed to each other in a manner sandwiching a feed channel of the record paper P (sandwiching the record paper P) therebetween, and the driving roller 952b is coupled to the paper feeding motor 951. By this structure, the paper feeding roller 952 feeds each of multiple sheets of the record paper P set in the tray 921 to the printing device 94. Instead of the tray 921, a paper feeding cassette containing the record paper P may be removably attached.

The controlling section 96 controls the printing device 94, the paper feeding device 95, and the like based on printing data inputted from a host computer, such as a personal computer or a digital camera, for performing printing. The controlling section 96 mainly includes a memory storing control programs controlling respective sections and the like, a piezoelectric element driving circuit driving piezoelectric elements 14 (a vibration source) to control discharging timing of the ink, a driving circuit driving the printing device 94 (the carriage motor 941), a driving circuit driving the paper feeding device 95 (the paper feeding motor 951), a communication circuit acquiring printing data from the host computer, and a CPU electrically coupled to these components to perform various kinds of controls at the respective sections, although the components are not shown in the drawing.

In addition, the CPU is electrically coupled to various kinds of sensors capable of detecting an amount of ink left in each of the ink cartridges 931 and a position of the head unit 93, for example. The controlling section 96 acquires the printing data via the communication circuit to store the data in the memory. The CPU processes the printing data to output a driving signal to each of the driving circuits based on the processed data and input data from the sensors. The piezoelectric element 14, the printing device 94, and the paper feeding device 95 respectively operate based on the driving signal. Thus, the printing is performed on the record paper P. Hereinafter, the head 10 will be described in detail with reference to FIGS. 7 and 8.

The head 10 includes a head main body 17 having a nozzle plate 11, an ink chamber substrate 12, a vibrating plate 13, and the piezoelectric elements 14 (the vibration source) bonded to the vibrating plate 13; and a base body 16 housing the head main body 17. The head 10 is an on-demand piezo-jet type head. For example, the nozzle plate 11 is made of a silicon material such as SiO₂, SiN, and quartz glass; a metal material such as Al, Fe, Ni, Cu, or an alloy of these metals; an oxide material such as alumina and iron oxide; a carbon material such as carbon black and graphite; or the like.

The nozzle plate 11 includes the multitude of nozzle holes 111 for discharging ink droplets. Pitches between the nozzle holes 111 are arbitrarily determined in accordance with printing precision. The ink chamber substrate 12 is bonded (fixed) to the nozzle plate 11. The ink cavity substrate 12 includes a plurality of ink chambers (cavities, pressure chambers) 121, a reservoir 123 storing ink supplied from the ink cartridge 931, and a supply hole 124 supplying the ink to each of the ink chambers 121 from the reservoir 123. The ink chambers 121, the reservoir 123, and the supply holes 124 are compartments formed by the nozzle plate 11, side walls (partition walls) 122, and the vibrating plate 13 described below.

Each of the ink chambers 121 is formed in a strip shape (a rectangular parallelepiped shape) and arranged corresponding to each of the nozzle holes 111. A bulk of the each of the ink chambers 121 can be changed by vibration of the vibrating plate 13 described below. The ink chamber 121 is configured so as to discharge ink by the bulk change thereof. Examples of a base material for the ink chamber substrate 12 include silicon monocrystalline substrates, substrates made of various glasses, and substrates made of various resins. These substrates are all versatile. Accordingly, using any of these substrates can reduce manufacturing cost of the head 10.

The vibrating plate 13 is bonded to a side, not facing the nozzle plate 11, of the ink chamber substrate 12, and the piezoelectric elements 14 are provided on a side, not facing the ink chamber substrate 12, of the vibrating plate 13. At a predetermined position of the vibrating plate 13, a through-hole 131 is formed in a manner penetrating through the vibrating plate 13 in a thickness direction of the plate 13. Via the through-hole 131, ink can be supplied to the reservoir 123 from the ink cartridge 931 described above.

Each of the piezoelectric elements 14 is composed of a lower electrode 142 and an upper electrode 141 with a piezoelectric layer 143 interposed therebetween, and disposed corresponding to approximately the center of one of the ink chamber 121. Each of the piezoelectric elements 14 is electrically coupled to the piezoelectric element driving circuit to be operated (vibrated and deformed) in response to a signal from the piezoelectric element driving circuit. The piezoelectric element 14 serves as a vibrating source, and vibration of the piezoelectric element 14 allows the vibrating plate 13 to vibrate so as to momentarily increase internal pressure in the ink chamber 121.

The base body 16 is made of various resin materials or various metal materials, for example. The nozzle plate 11 is fixed to the base body 16 to be supported by the base body 16. Specifically, an edge portion of the nozzle plate 11 is supported by a stepped portion 162 formed at an outer periphery of a recessed portion 161 in a state that the head main body 17 is stored in the recessed portion 161 of the base body 16. Among the bonding between the nozzle plate 11 and the ink chamber substrate 12, the bonding between the ink chamber substrate 12 and the vibrating plate 13, and the bonding between the nozzle plate 11 and the base body 16, at least one bonding is performed by using the bonding method of the embodiments.

In other words, the bonded body of any of the embodiments is applied to at least one among a bonded body of the nozzle plate 11 and the ink chamber substrate 12, a bonded body of the ink chamber substrate 12 and the vibrating plate 13, and a bonded body of the nozzle plate 11 and the base body 16. The head 10 is formed such that substrates and the like are bonded to each other with the bonding film 3, as described above, interposed therebetween at the bonded interfaces. This increases bonding strength and solvent resistance of the bonded interface, thereby improving durability and liquid tightness with respect to ink stored in each ink chamber 121. As a result, the head 10 is formed to be highly reliable.

In addition, since highly reliable bonding can be achieved at a very low temperature, there is an advantage that a large-area head can be obtained even by using materials having different linear expansion coefficients from each other. Using the bonded body of the embodiment as a part of the head 10 allows the head 10 to have high dimensional accuracy. Therefore, a high level of control can be achieved over the discharging direction of ink droplets discharged from the head 10 and a distance between the head 10 and the record paper P, thereby improving quality of a print result obtained by the inkjet printer 9.

Further, a position to which the liquid material is applied can be arbitrarily set by employing the droplet discharging method. Therefore, local concentration of stress occurring at the bonded interface of each bonded body can be reduced by arbitrarily controlling an area or a position of a bonding part of the bonded body. Accordingly, even when thermal expansion coefficients are largely different in each pair of the nozzle plate 11 and the ink chamber substrate 12, the ink chamber substrate 12 and the vibrating plate 13, and the nozzle plate 11 and the base body 16, members of the each pair can be securely bonded to each other.

Further, reduce of the local concentration of stress occurring at the bonded interface can securely prevent separation or deformation (warpage) of the bonded body. As a result, the head 10 and the inkjet printer 9 having high reliability can be obtained. In the head 10 thus formed, the piezoelectric layer 143 is not deformed in a state where no predetermined discharging signal is inputted from the piezoelectric element driving circuit, that is, in a state where no voltage is applied between the lower and the upper electrodes 142 and 141 of the piezoelectric element 14. Accordingly, the vibrating plate 13 is not deformed, and therefore the bulk of the ink chamber 121 is not changed. As a result, no ink droplet is discharged from the nozzle hole 111.

On the other hand, the piezoelectric layer 143 is deformed in a state where a predetermined signal is inputted from the piezoelectric element driving circuit, that is, in a state where a predetermined voltage is applied between the lower and the upper electrodes 142 and 141 of the piezoelectric element 14. Accordingly, the vibration plate 13 is largely bent, changing the bulk of the ink chamber 121. At this time, pressure inside the ink chamber 121 is momentarily increased, whereby ink droplets are discharged form the nozzle hole 111.

After completion of one-time ink discharging, the piezoelectric element driving circuit stops applying a voltage between the lower and the upper electrodes 142 and 141. Thereby, the shape of the piezoelectric element 14 returns to substantially the original shape, and thus, the bulk of the ink chamber 121 is increased. At this point, ink is in the influence of pressure directing from the ink cartridge 931 toward the nozzle hole 111 (pressure in a positive direction). This prevents entry of air from the nozzle hole 111 into the ink chamber 121, resulting in supply of ink, having an amount corresponding to an amount of ink to be discharged, to the ink chamber 121 from the ink cartridge 931 (the reservoir 123).

In this manner, in the head 10, a discharging signal is sequentially inputted to the piezoelectric element 14 located at an intended position for printing via the piezoelectric element driving circuit, being able to print arbitrary (desired) characters, figures, and the like. Alternatively, the head 10 may include an electrothermal converting element instead of the piezoelectric element 14. That is, the head 10 may be a head of a bubble jet (“bubble jet” is a registered trademark) system using thermal expansion of a material by the electrothermal converting element.

In the head 10 structured as above, a coating film 114 for imparting repellency is formed on the nozzle plate 11. The coating film 114 can securely prevent ink droplets from being left around the nozzle hole 111 when the ink droplets are discharged from the nozzle hole 111. As a result, the ink droplets discharged from the nozzle hole 111 can be securely landed on an intended region. Hereinabove, the bonding method and the bonded body of the invention have been described with reference to the drawings, but the invention is not limited to the embodiments.

For example, one or more of arbitrary steps may be added to the bonding method according to need. Note that application of the bonded body of the invention is not limited to the droplet discharge head. Specifically, the bonded body is applicable to one that does not require solvent resistance. Examples of such bonded body include a lens of an optical device, a semiconductor device, a microreactor, and the like.

### EXAMPLES

Specific examples of the invention will now be described.

1. Manufacture of Bonded Body

Bonded bodies were manufactured in the following examples and comparative examples by three pieces per each example.

### Example 1

First, a monocrystalline silicon substrate and a glass substrate were prepared respectively as a first base member and a second base member, and a base treatment was performed on both of the substrates by oxygen plasma. Each of the substrates had a length of 20 mm, a width of 20 mm, and an average thickness of 1 mm.

A liquid material containing a silicone material having a polydimethylsiloxiane skeleton and a solvent of toluene and isobutanol (“KR-251” which is a product of Shin-Etsu Chemical Co., Ltd, and has a viscosity of 18.0 mPa·s at 25° C.) was prepared, and the liquid material was applied to the silicon substrate by spin coating so as to form a liquid film. Then, the liquid film was dried for 24 hours at room temperature (25° C.) so as to form a bonding film (average thickness of approximately 3 μm) on the silicon substrate.

The bonding film was heated for one hour at 150° C. so that the silicone materials contained in the bonding film were cross-linked to each other. A measurement of a contact angle of pure water on a surface of the bonding film after heating was made by using a solid-liquid interface analysis system (“DM-700” which is a product of Kyowa Interface Science Co., Ltd). The contact angle was 104.6° (average value of the contact angles measured on the bonding film of each bonded body (n=3)). Subsequently, plasma was brought into contact with the bonding film, which had been formed on the silicon substrate, by the atmospheric-pressure plasma apparatus shown in FIG. 3 under the following conditions. Thereby the bonding film was activated and adhesiveness was developed on the surface of the film.

Conditions of Plasma Treatment

Treatment gas: helium gas
Gas supplying speed: 10 SLM
Interval between electrodes: 1 mm
Applied voltage: 1 kVp-p
Voltage frequency: 40 MHz
Moving speed: 5 mm/sec.

Then, the silicon substrate and the glass substrate were superposed in a manner that a surface, with which the plasma had been brought into contact, of the bonding film is brought into contact with a surface of the glass substrate. Subsequently, the silicon substrate and the glass substrate were pressurized at 50 MPa at room temperature (approximately 25° C.) and kept in the state for a minute. As a result, a bonded body was obtained that included the silicon substrate and the glass substrate bonded to each other with the bonding film interposed therebetween.

### Examples 2 to 5

Each bonded body was obtained in the same manner as in Example 1 excepting that those materials shown in Table 1 were used as the materials for the first base member and the second base member.

### Example 6

The bonded body was obtained in the same manner as in Example 1 excepting that the bonding film was heated after the formation of the bonded body, not prior to the formation of the bonded body. A measurement of a contact angle of pure water on the surface of the bonding film prior to the plasma had been brought into contact with was made by using the solid-liquid interface analysis system (“DM-700” which is a product of Kyowa Interface Science Co., Ltd). The contact angle was 99.5° (average value of the contact angles measured at the bonding film of each bonded body was (n=3)).

### Examples 7 to 10

Each bonded body was obtained in the same manner as in Example 6 excepting that those materials shown in Table 1 were used as the materials for the first base member and the second base member.

### Example 11

The bonded body was obtained in the same manner as in Example 1 except for using a liquid material containing the silicone material having a polydimethylsiloxane skeleton and no solvent (“KR-400” which is a product of Shin-Etsu Chemical Co., Ltd. and has a viscosity of 1.20 mPa·s at 25° C.).

### Example 12

First, a monocrystalline silicon substrate and a glass substrate were prepared respectively as a first base member and a second base member, and a base treatment was performed on both of the substrates by oxygen plasma. Each of the substrates had a length of 20 mm, a width of 20 mm, and an average thickness of 1 mm.

A liquid material containing a silicone material having a polydimethylsiloxiane skeleton and a solvent of toluene and isobutanol (“KR-251” which is a product of Shin-Etsu Chemical Co., Ltd, and has a viscosity of 18.0 mPa·s at 25° C.) was prepared, and the liquid material was applied to the silicon substrate and the glass substrate by spin coating so as to form a liquid film on each of the silicon substrate and the glass substrate. Then, the liquid films were dried for 24 hours at room temperature (25° C.) so as to respectively form a bonding film (average thickness of approximately 3 μm) on the silicon substrate and the glass substrate.

The bonding films formed on each of the substrates were heated for one hour at 150° C. so that the silicone materials contained in the bonding films were cross-linked to each other. Subsequently, plasma was brought into contact with the bonding films, which had been formed on each substrate, by the atmospheric-pressure plasma apparatus shown in FIG. 3 under the following conditions. Thereby the bonding films were activated and adhesiveness was developed on the surface of each film.

Conditions of Plasma Treatment

Treatment gas: helium gas
Gas supplying speed: 10 SLM
Interval between electrodes: 1 mm
Applied voltage: 1 kVp-p
Voltage frequency: 40 MHz
Moving speed: 5 mm/sec.

Then, the silicon substrate and the glass substrate were superposed in a manner that a surface of the bonding film and a surface of the glass substrate were brought into contact with each other. Subsequently, the silicon substrate and the glass substrate were pressurized at 50 MPa at room temperature (approximately 25° C.) and kept in the state for a minute. As a result, the bonded films are integrated with each other, obtaining a bonded body that included the silicon substrate and the glass substrate bonded to each other with the bonding film interposed therebetween.

### Comparative Example 1

The bonded body was obtained in the same manner as in Example 1 excepting that the heating the bonding film was omitted.

### Comparative Examples 2 to 5

Each bonded body was obtained in the same manner as in Comparative Example 1 excepting that those materials shown in Table 1 were used as the materials for the first base member and the second base member.

2. Evaluation of Bonded Body

2.1 Evaluation of Bonding Strength (Splitting Strength)

Bonding strength was measured in each of the bonded bodies obtained in Examples and Comparative Examples. Measurements of the bonding strength were carried out by measuring strength obtained immediately before separation of each base member when the base members were separated. Then, obtained bonding strength was evaluated in accordance with following criteria:

Evaluation Criteria of Bonding Strength

A: 10 MPa (100 kgf/cm²) or more
B: 5 MPa (50 kgf/cm²) or more and less than 10 MPa (100 kgf/cm²)
C: 1 MPa (10 kgf/cm²) or more and less than 5 MPa (50 kgf/cm²)
D: Less than 1 MPa (10 kgf/cm²)

2.2 Warpage

Measurements of warpage in a thickness direction of each of the bonded bodies obtained in Examples and Comparative Examples were made. The measurements were carried out by measuring distances from a reference point to four corners of the bonded body in a thickness direction of the bonded body where a position at the center of the bonded body was set as the reference point. The average distance was obtained as the warpage. The calculated warpage value was evaluated in accordance with following criteria:

Evaluation Criteria of Warpage

A: Less than 2 mm
B: Less than 3 mm and 2 mm or more
C: Less than 4 mm and 3 mm or more
D: 4 mm or more

2.3 Presence of Air Bubbles

The presence of air bubbles were visually confirmed in each of the bonded bodies obtained in Examples and Comparative Examples.

Evaluation Criteria of Presence of Air Bubbles

A: Air bubbles were not confirmed
B: Some air bubbles were confirmed
C: Air bubbles were evidently confirmed
D: Air bubbles were evidently confirmed all over the bonding film

2. 4 Evaluation of Solvent Resistance

Each of the bonded bodies obtained in Examples and Comparative Examples were immersed in an inkjet printer ink (an industrial ink) maintained at 90° C. for six weeks under following conditions. After that, each base member was separated to check the presence of ink at a bonded interface. Results were evaluated in accordance with following criteria:

Evaluation Criteria of Solvent resistance

A: no ink was present
B: a slight amount of ink was present in the corner
C: ink was present along the periphery
D: ink was present in the interface
Table 1 shows results obtained in the evaluations of 2-1 to 2-4.

TABLE 1

| | Manufacturing Conditions of Bonded Body | | | | | | | | |
|---|---|---|---|---|---|---|---|---|---|
| | Material | Material of | | Material of | | Evaluation Results | | | |
| | of First | Bonding Film | Material of | Bonding Film | Heating | | | Presence | |
| | Base | on First Base | Second Base | on Second | Bonding | Bonding | | of Air | Solvent |
| | Member | Member | Member | Base Member | Film | Strength | Warpage | Bubbles | Resistance |
| Example 1 | Silicon | KR-251 | Glass | — | Prior to | A | A | A | A |
| Example 2 | | | Silicon | | Formation of | A | A | A | A |
| Example 3 | | | Stainless Steel | | Bonding Film | A | A | A | A |
| Example 4 | | | Aluminum | | | B | A | A | A |
| Example 5 | | | PET | | | B | A | A | A |
| Example 6 | | | Glass | | After | B | A | B | A |
| Example 7 | | | Silicon | | Formation of | B | A | B | A |
| Example 8 | | | Stainless Steel | | Bonding Film | B | B | B | A |
| Example 9 | | | Aluminum | | | B | B | B | A |
| Example 10 | | | PET | | | B | B | B | A |
| Example 11 | | KR-400 | Glass | — | Prior to | A | A | A | A |
| Example 12 | | KR-251 | | KR-251 | Formation of | A | A | A | A |
| | | | | | Bonding Film | | | | |
| Comparative | | KR-251 | Glass | — | — | A | A | A | C |
| Example 1 | | | | | | | | | |
| Comparative | | | Silicon | | | A | A | A | C |
| Example 2 | | | | | | | | | |
| Comparative | | | Stainless | | | B | A | A | C |
| Example 3 | | | Steel | | | | | | |
| Comparative | | | Aluminum | | | B | A | A | C |
| Example 4 | | | | | | | | | |
| Comparative | | | PET | | | B | A | A | C |
| Example 5 | | | | | | | | | |

*Note: PET represents polyethylene terephthalate

As is apparent from Table 1, the bonded bodies obtained in Examples 1 to 5 exhibited excellent characteristics in each category of the bonding strength, the warpage, the presence of air bubbles, and the solvent resistance. On the other hand, the bonded bodies obtained in Examples 6 to 10 exhibited inferior characteristics, comparing with the bonded bodies obtained in Examples 1 to 5, in the category of the warpage and the presence of air bubbles. As a result, it is obvious that warpage and the presence of air bubbles can be efficiently suppressed by heating to the bonding film prior to the formation of the bonded body.

The bonded bodies obtained in Examples 6 to 10 exhibited inferior characteristics, comparing with the bonded bodies obtained in Examples 1 to 5, in the category of the bonding strength depending on the material of the second base member. As a result, it is obvious that bonding strength of the bonding film can be efficiently improved by heating the bonding film prior to the formation of the bonded body. As described above, the contact angle of the bonding film after the heating was 104.6° C. and that of the bonding film without the heating was 95.5° C. It is assumed that the heating the bonding film allows more hydrocarbon groups to be exposed on the film surface, thereby the extent of activation of the film surface when the plasma is brought into contact was further improved. Comparing with the bonded bodies obtained in Examples 1 to 5, though the bonded bodies obtained in Comparative Examples 1 to 5 exhibited comparable characteristics in each category of the bonding strength, the warpage and the presence of air bubbles, they exhibited inferior characteristics in the category of solvent resistance. As a result, it became apparent that solvent resistance of the bonding film can be efficiently improved by heating the bonding film so as to cross-link the silicone materials.

What is claimed is:

1. A bonding method, comprising:
applying a liquid material containing silicone materials to at least one of the first base member and the second base member so as to form a liquid film;
drying the liquid film so as to obtain a bonding film on the at least one of the first base member and the second base member;
heating the bonding film so as to cross-link the silicone materials contained in the bonding film to each other; and
applying energy to the bonding film so as to develop adhesiveness around a surface of the bonding film so as to obtain a bonded body in which the first base member and the second base member are bonded to each other with the bonding film interposed between the first base member and the second base member.

2. A bonding method, comprising:
applying a liquid material containing silicone materials to at least one of the first base member and the second base member so as to form a liquid film;
drying the liquid film so as to obtain a bonding film on the at least one of the first base member and the second base member;
applying energy to the bonding film so as to develop adhesiveness around a surface of the bonding film so as to obtain a bonded body in which the first base member and the second base member are bonded to each other with the bonding film interposed between the first base member and the second base member; and
heating the bonding film so as to cross-link the silicone materials contained in the bonding film to each other.

3. The bonding method according to claim 1, wherein the bonding film is heated at a temperature ranging from 80° C. to 250° C.

4. The bonding method according to claim 1, wherein the bonding film is heated for 0.2 hours to 15 hours.

5. The bonding method according to claim 1, wherein the energy is applied by bringing plasma into contact with the bonding film.

6. The bonding method according to claim 5, wherein the plasma contact is performed in atmospheric pressure.

7. The bonding method according to claim 5, wherein the plasma is brought into contact with the bonding film by introducing a gas between electrodes opposed to each other so as to convert the gas into plasma while a voltage is applied between the electrodes so as to supply the bonding film with the gas converted into plasma.

8. The bonding method according to claim 5, wherein the plasma is obtained by converting a gas mainly containing a helium gas.

9. The boning method according to claim 1, wherein the silicone materials include polyorganosiloxane skeletons as a main skeleton.

10. The boning method according to claim 1, wherein the silicone materials include silanol groups, and the silanol groups included in the adjacent silicone materials react so as to cross-link the silicone materials to each other.

11. The bonding method according to claim 1, wherein the bonding film has an average thickness of 10 nm to 10,000 nm.

12. The bonding method according to claim 1, wherein at least portions of the first base member and the second base member contacting the bonding film is mainly made of one of a silicon material, a metal material, and a glass material.

13. The bonding method according to claim 1, wherein surfaces of the first base member and the second base member contacting the bonding film are surface treated in advance so as to increase adhesiveness with the bonding film.

14. The bonding method according to claim 13, wherein the surface treatment is one of a plasma treatment and an ultraviolet (UV) radiation treatment.

15. A bonded body obtained by bonding the first base member and the second base member with the bonding film interposed between the first base member and the second base member by the bonding method of claim 1.
